(19) United States
(12) Patent Application Publication
(10) Pub. No.: US 2026/0330140 A1
(43) Pub. Date: Oct. 22, 2026

(54) SYSTEM

(71) Applicant: SoftBank Group Corp., Tokyo (JP)

(72) Inventor: Tomoya NAKAMURA, Tokyo (JP)

(73) Assignee: SoftBank Group Corp., Tokyo (JP)

(21) Appl. No.: 19/650,351

(22) Filed: Apr. 17, 2026

(30) Foreign Application Priority Data
Apr. 22, 2025 (JP) 2025-070657

(51) Int. Cl. G06F 40/284; G06F 16/334; G06F 16/358; G06F 40/30; G10L 15/26; G10L 25/63

(52) U.S. Cl. CPC G06F 40/284; G06F 16/3344; G06F 16/358; G06F 40/30; G10L 15/26; G10L 25/63

(57) ABSTRACT

The present invention relates to an employee support system that enables workers to anonymously and safely consult about concerns such as power harassment, subtle workplace harassment, and mental health issues. The system includes a consultation receiving unit that collects employee input, and an analysis unit that applies natural language processing and generative AI-based emotion analysis. It performs keyword extraction, summary generation, emotion scoring, and comparison with a database of past cases. A support guidance unit then delivers tailored feedback and advice based on the analysis and relevant prior cases. When appropriate, it can guide users to support resources such as an industrial physician or human resources, assist with appointment scheduling, and generate reports automatically. The system also features privacy protection, multilingual capabilities, and trend analysis functions, ultimately helping improve employee mental well-being and creating a more supportive and productive workplace environment.

### CROSS-REFERENCE TO RELATED APPLICATION

The present application claims priority to and incorporates by reference the entire contents of Japanese Patent Application No. 2025-070657 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is to provide an environment in which an employee can consult anonymously and with peace of mind, quickly and accurately analyze consultation content by advanced natural language processing and emotion analysis technology utilizing generative AI, automatically present optimal feedback and advice referring to a past in-house case database, and as necessary, guide to an appropriate support destination such as an industrial physician or a human resources department, automatically set an appointment, automatically generate a report including a summary of the consultation content and an analysis result, and realize thorough privacy protection, thereby simultaneously achieving an improvement in mental health of the employee and an improvement in ease of working of the entire company, in response to a conventional problem that an employee suffering from a physical and mental disorder due to power harassment, insidious harassment, or a personal problem cannot determine whether his/her situation falls under harassment, and there is a psychological barrier that the employee cannot easily consult with people around him/her due to the nature of the consultation content, or it is difficult to consult even with a consultation desk set up in a company, and furthermore, it is difficult to determine how serious the problem should be treated, and as a result, the employee cannot reach appropriate support or a solution at an appropriate timing, causing serious problems such as deterioration of the mental health of the employee, deterioration of a workplace environment, and consequently a decrease in productivity and an increase in a turnover rate of the entire company.

### SUMMARY OF THE INVENTION

Means for solving the problem according to the present invention is to configure an employee support system comprising a consultation receiving unit, an analysis unit, and a support guidance unit, wherein the consultation receiving unit receives consultation content from an employee, and records the consultation content as a session log together with time information; the analysis unit performs keyword extraction and summary generation by a natural language processing model on the received consultation content using generative AI, digitizes an intensity of a negative emotion included in the consultation content by an emotion analysis model, automatically determines a sign of power harassment, insidious harassment, or a mental disorder based on the extracted keyword and an emotion score, further searches for a past case similar to the consultation content by referring to a past personnel case database accumulated in a company, and extracts a countermeasure of the past case; the support guidance unit presents optimal feedback and advice to the employee based on a determination result by the analysis unit and the countermeasure of the past case, specifies a support destination such as an industrial physician, a human resources department, or a consultation desk as necessary to automatically set an appointment with the support destination, and further automatically generates a report including a summary of the consultation content, an analysis result, advice, and the like to provide the report to the support destination in advance; and the employee support system has a function of anonymizing personal information for privacy protection of the employee in all processes, is customizable for an external company according to a personnel system and a past case database of each company, and provides an environment in which the employee can consult anonymously and with peace of mind.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

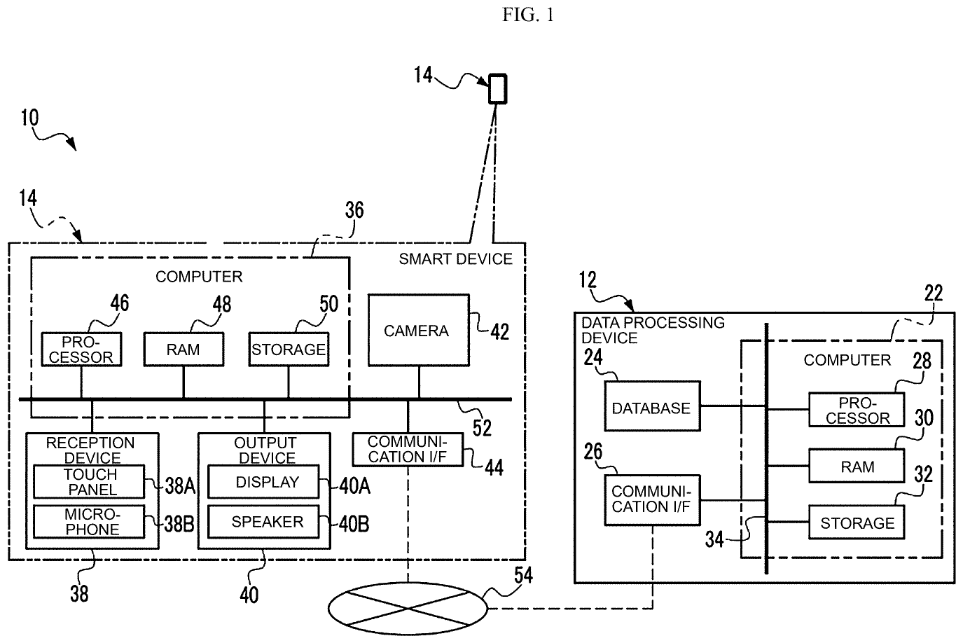

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

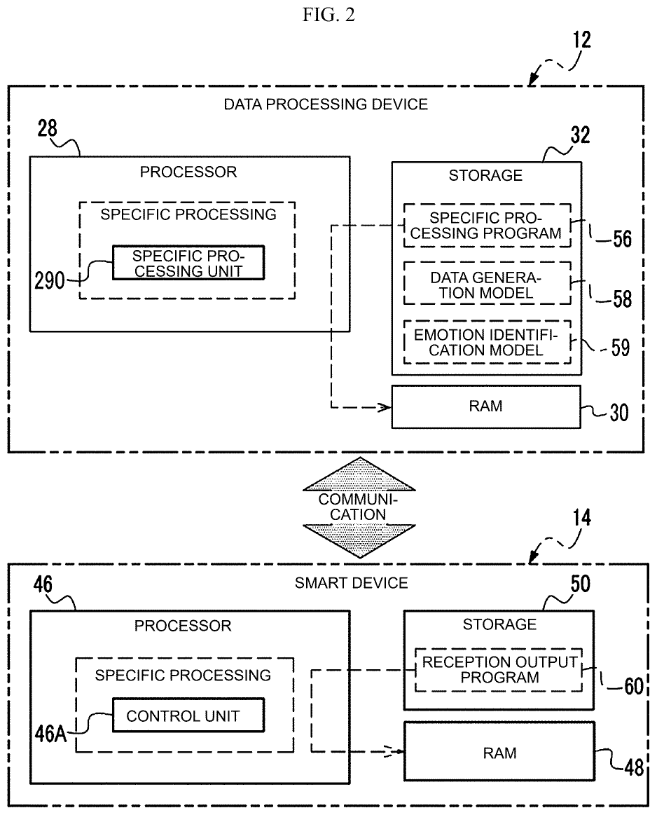

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The employee support system of the present invention is composed of a server and a terminal, and has a consultation receiving unit, an analysis unit, and a support guidance unit. The terminal is an information terminal such as a personal computer, a smartphone, a tablet, or a wearable device used by an employee, and the server is a high-performance computing resource installed in a cloud environment or on an in-house network. The terminal and the server communicate via a network such as the Internet or an intranet. Specifically, the present system adopts a distributed processing architecture. The present server includes a parallel computing cluster using a plurality of GPUs. The present system executes an operation in a high-dimensional vector space. The present server accelerates inference processing of a large language model. The present system does not merely automate a human mental process. The present system improves processing efficiency of computer technology itself. The present terminal acquires input data from a user as a digital signal. The present terminal packetizes the input data. The present terminal transmits the packet to the present server using a TCP/IP protocol. The present server includes a load balancer. The present load balancer optimally distributes communication traffic to a plurality of computing nodes. Thereby, the present system minimizes a response delay even when the number of simultaneous connections increases. The present system significantly reduces a communication load. The present system improves availability of the entire system. The present system is applied as an employee support platform in a large-scale corporate organization. The present system exhibits an extremely high technical effect in a use case of processing simultaneous accesses from tens of thousands of employees.

First, a user interface of the consultation receiving unit is realized on the terminal side, and the employee accesses the system using a dedicated application, a web browser, a chatbot, a voice input interface, or the like. For example, the employee can input specific worries and situations in a free description format, such as “I am yelled at by my boss every day and feel mentally at my limit”, “I am ignored by my colleagues and isolated”, “The amount of work is too much and I am about to get sick, but I cannot consult anyone”, “Backbiting and harassment continue in the workplace and I am afraid to go to work”, or “I am blamed more than necessary for mistakes at work, and days when I cannot sleep continue”. In the case of voice input, it is also possible to perform voice recognition processing on the terminal side, convert it into text data, and transmit it to the server. Specifically, the present terminal acquires input natural language text as a character code array. In the case of voice input, the present terminal acquires an analog voice signal via a built-in microphone. The present terminal samples the analog voice signal and converts it into digital voice data. The present terminal extracts an acoustic feature vector such as a mel-frequency cepstral coefficient from the digital voice data. The present terminal executes voice recognition processing using a hidden Markov model or a recurrent neural network. The present terminal receives the acoustic feature vector as input data. The present terminal generates a text character string as output data. The present terminal transmits the generated text character string to the present server. The present system executes the voice recognition processing on the terminal side. Thereby, the present system reduces a data transfer amount to the server. The present system suppresses consumption of a network bandwidth. The present system improves real-time responsiveness. The present system realizes diversification of input interfaces. The present system provides accessibility even to a user in a situation where keyboard input is difficult. The present system exhibits a remarkable technical effect in a use case of receiving a consultation by voice from an employee at a manufacturing site or on the move.

The input consultation content is transmitted from the terminal to the server by encrypted communication, and is recorded as a session log together with information such as a consulter ID (or an anonymous token), an input date and time, consultation content text, a terminal type, an IP address, position information (when permitted), and a consultation category (when optional) in the consultation receiving unit on the server side. For example, it is designed so that even when the employee consults a plurality of times, a past consultation history can be managed in chronological order. Specifically, the present terminal encrypts the input data using a public key cryptography method. The present terminal generates an encrypted data payload. The present server decrypts the received data payload using a private key. The present server converts the decrypted data into structured data. The present server stores the session log in a distributed relational database or a NoSQL database. The present server indexes the data using the consulter ID as a primary key. The present server constructs a B-tree index or a hash index. The present server executes partitioning based on a time stamp for time-series data. Thereby, the present server accelerates search processing for large-scale log data. The present system dramatically improves data read/write performance. The present system ensures data integrity and confidentiality by a mathematical algorithm. The present system reduces a risk of information leakage. The present system exhibits an extremely important technical effect in a use case of providing continuous support while protecting the privacy of the employee. The present system provides a foundation for extracting past history data at high speed.

Next, the analysis unit on the server side utilizes the generative AI to analyze the consultation content from multiple angles. The generative AI used here integrates a plurality of natural language processing technologies such as a large language model, an emotion analysis model, a summary generation model, and a similar case search model. First, the consultation content text is input into the natural language processing model of the generative AI, and a characteristic keyword (for example, “abusive language”, “ignoring”, “excessive reprimand”, “personality denial”, “overwork”, “isolation”, “backbiting”, “harassment”, “power harassment”, “sexual harassment”, “moral harassment”, “bullying”, “mental distress”, “poor physical condition”, “insomnia”, “palpitation”, “cannot stop crying”, “difficulty going to work”, or the like) is extracted from the consultation sentence. Since the keyword extraction is performed in consideration of not only a word level but also a context and a nuance of an expression, for example, an expression such as “Recently, I am afraid to go to the workplace”, “No one talks to me”, or “I am yelled at every day” is also appropriately recognized. Specifically, the present analysis unit executes a neural network of a transformer architecture provided with a self-attention mechanism. The present analysis unit tokenizes the input text in units of subwords. The present analysis unit converts each token into a 512-dimensional word embedding vector. The present analysis unit adds positional encoding to the word embedding vector. The present analysis unit receives a token array of text “I am yelled at by my boss every day and feel mentally at my limit” as input data. The present analysis unit calculates a dependency relationship between tokens in a multi-layer self-attention layer. The present analysis unit generates an array of importance scores of each token as output data. The present analysis unit extracts a token whose importance score exceeds a predetermined threshold as a keyword. The present analysis unit inputs the extracted keyword to a subsequent similar case search module. The present system analyzes a context not by simple dictionary matching but by a vector operation in a high-dimensional space. Thereby, the present system realizes highly accurate keyword extraction even for an unknown expression or an ambiguous expression. The present system significantly improves accuracy of natural language processing. The present system exhibits a remarkable technical effect in a use case of analyzing trouble in complex human relations.

Furthermore, the generative AI automatically generates a summary of the entire consultation content. For example, it outputs a summary sentence that allows a third party to grasp the situation of the consulter at a glance, such as “Feeling a mental burden due to continuous abusive language and ignoring from the boss”, “Backbiting and harassment from colleagues continue, making it difficult to go to work”, or “Poor physical condition due to an increase in the amount of work, and days when I cannot sleep continue”. The summary generation is designed to reflect the subjective emotion of the consulter and the severity of the situation. Specifically, the present analysis unit executes a summary generation model having an encoder-decoder structure. The present summary generation model generates a fixed-length context vector from a sequence of input word embedding vectors. The present summary generation model autoregressively generates a token sequence of summary text from the context vector. The present summary generation model searches for an optimal token sequence using a beam search algorithm. The present summary generation model receives a tensor of long consultation text as input data. The present summary generation model generates a character string of compressed summary text as output data. The present summary generation model is pre-trained using a cross-entropy error function. The present summary generation model optimizes fluency and information comprehensiveness of the summary using reinforcement learning. The present system does not imitate a human summary work but executes a mathematical generation process based on a probabilistic language model. Thereby, the present system instantaneously compresses long text data. The present system dramatically improves efficiency of information processing. The present system exhibits an extremely high technical effect in a use case where a person in charge of human resources quickly triages a large amount of consultation cases.

In addition, the emotion analysis model of the generative AI analyzes an emotion included in the consultation content, and digitizes a plurality of emotion parameters such as a negative emotion score, a stress index, an anxiety level, a depressive tendency, anger, sadness, fear, and a sense of helplessness. For example, when many expressions such as “painful”, “suffering”, “limit”, “cannot sleep”, “want to die”, “impossible anymore”, and “no one helps me” are included, the negative emotion score becomes 0.9 or more, and it is determined as a sign of a serious mental disorder. Since the emotion analysis is performed in consideration of not only the frequency of words and phrases but also the context and the past consultation history of the consulter, for example, a tendency such as “expressions are heavier than before” or “consultation frequency is increasing” can also be automatically detected. Specifically, the present analysis unit executes a convolutional neural network or a long short-term memory network as the emotion analysis model. The present emotion analysis model receives a distributed representation tensor of text and a time-series vector of the past consultation history as input data. The present emotion analysis model generates a plurality of emotion score vectors taking continuous values in a range of 0.0 to 1.0 as output data. The present emotion analysis model outputs a numerical value of 0.92 as the negative emotion score, for example. The present emotion analysis model outputs a numerical value of 0.85 as the anxiety level score. The present analysis unit inputs the output emotion score vector to a subsequent threshold determination processing module. The present analysis unit generates an emergency alert flag when the emotion score exceeds a predetermined threshold. The present system quantifies a subjective concept of emotion as coordinates on a multidimensional vector space. Thereby, the present system realizes objective and reproducible evaluation that does not depend on human intuition. The present system improves accuracy of early detection of a sign of deterioration in mental health. The present system exhibits an extremely important technical effect in a use case of triggering an emergency intervention to prevent a serious situation.

The analysis unit further refers to a past personnel case database accumulated in the company. In this database, past consultation cases, countermeasures, results, involved support destinations (an industrial physician, a human resources department, a consultation desk, an external counselor, etc.), recurrence prevention measures, a period from consultation to resolution, a recurrence rate, employee satisfaction, presence or absence of follow-up, and the like are recorded. The generative AI collates the keyword and the summary of the consultation content with the content of the past cases, and automatically extracts a similar case and its countermeasure, such as “In a case where ‘ignoring’ and ‘abusive language’ occurred simultaneously in the past, an interview with an industrial physician and an investigation by the human resources department were conducted, and a reassignment for a certain period was performed”, “In a case where ‘backbiting’ and ‘harassment’ continued, counseling by an external counselor and a team building measure were effective”, or “In a case of poor physical condition due to ‘overwork’, work load adjustment and a regular follow-up interview were conducted, leading to recurrence prevention”. When a plurality of similar cases exist, optimal feedback is generated by also taking into consideration the effect of the countermeasure, the recurrence rate, the employee satisfaction, and the like. Specifically, the present analysis unit vectorizes each case text in the past case database in advance. The present analysis unit converts each case into a 768-dimensional dense vector using a sentence embedding model. The present analysis unit similarly converts the summary text of the consultation content into a 768-dimensional dense vector. The present analysis unit calculates a distance between vectors in a high-dimensional space using cosine similarity. The present analysis unit receives the dense vector of the consultation content as input data. The present analysis unit generates an identifier list of past cases having higher similarity scores as output data. The present analysis unit acquires numerical data such as the recurrence rate and the employee satisfaction from metadata of the extracted past cases. The present analysis unit weights and corrects the similarity score using these numerical data. The present system executes a vector search based on semantic similarity instead of a simple keyword search. Thereby, the present system absorbs orthographical variants and differences in expression, and realizes highly accurate case extraction. The present system significantly improves search efficiency of the database. The present system exhibits a remarkable technical effect in a use case of formalizing past tacit knowledge and deriving an optimal solution.

The support guidance unit presents optimal feedback and advice to the employee on the terminal based on the determination result by the analysis unit and the countermeasure of the past case. For example, the generative AI automatically generates specific and situation-dependent advice, such as “Since the current situation is highly likely to be serious harassment, consultation with an industrial physician or a human resources department is recommended”, “In a similar case in the past, early consultation with a consultation desk was effective”, “First, prioritize physical condition management, and a leave of absence can be considered as necessary”, “There is a case that improved by receiving counseling by an external counselor”, or “There is a case where work load adjustment or department transfer led to recurrence prevention”, and displays the advice on a screen of the terminal. The feedback is designed to use empathetic and positive expressions in order to reduce the psychological burden on the consulter. Specifically, the present support guidance unit executes a combination of a rule-based inference engine and the generative AI. The present support guidance unit receives the emotion score vector and the identifier of the similar case as input data. The present support guidance unit generates a probability distribution of a recommended action as output data. The present support guidance unit selects a recommended action having the highest probability. The present support guidance unit inputs the selected recommended action as a prompt to the generative AI. The present generative AI generates feedback text in natural language based on the prompt. The present support guidance unit converts the generated text into display data in an HTML or JSON format. The present support guidance unit transmits the display data to the present terminal. The present system executes processing of converting a mechanical determination result into natural language that is easy for a human to understand. Thereby, the present system improves affinity of the user interface. The present system enhances system acceptability of the user. The present system exhibits an extremely high technical effect in a use case of automatically executing a personalized initial intervention for the employee.

Furthermore, when the employee desires or when the system determines it necessary, the support guidance unit automatically specifies a support destination such as an industrial physician, a human resources department, a consultation desk, or an external counselor, and automatically sets an appointment on the server side. For example, it searches for an open schedule of the industrial physician, automatically proposes the earliest possible date and time for an interview, and confirms a reservation by collating with the convenience of the employee. After the reservation is confirmed, the generative AI automatically generates a detailed report including the summary of the consultation content, the extracted keyword, the emotion analysis result, the main point of the past case, the recommended advice, and the like, and provides the report to the support destination in advance. The report includes the anonymous token of the consulter, the summary of the consultation content, the emotion score, a comparison with the past case, a recommended countermeasure, a proposal for follow-up, and the like. For example, information that enables the support destination to respond quickly and accurately is comprehensively described, such as “The consulter has consulted three times in the past two weeks, and the negative emotion score is on an upward trend” or “In a similar case in the past, an interview with an industrial physician and work load adjustment were effective, so a similar response is recommended”. Specifically, the present support guidance unit cooperates with an external calendar API. The present support guidance unit acquires an open slot for an appointment as a time-series array. The present support guidance unit calculates an optimal date and time using an algorithm of a constraint satisfaction problem. The present support guidance unit receives a desired date and time vector of the employee and an open slot vector of the support destination as input data. The present support guidance unit generates a time stamp of the confirmed reservation date and time as output data. The present support guidance unit activates a report generation module triggered by the confirmation of the reservation. The present report generation module integrates the extracted keyword array and emotion score vector as structured data. The present report generation module converts the structured data into a report file in a PDF or HTML format using a template engine. The present system automates data linkage between a plurality of systems. Thereby, the present system eliminates an overhead of manual schedule adjustment. The present system dramatically improves processing speed of the entire business process. The present system exhibits a remarkable technical effect in a use case where a supporter accurately grasps the situation of the consulter before an interview and prepares an effective intervention.

In addition, in order to thoroughly ensure privacy protection of the employee in all processes, it has a function of anonymizing personal information on the server side. For example, the consulter ID is converted into a random token, and information that can identify an individual is not included in the consultation content or the report. Access logs and databases are also encrypted, and it is designed so that personal information cannot be accessed even with administrator privileges. Furthermore, the system can be provided to an external company, and learning data of the generative AI and feedback content can be customized according to a personnel system and a configuration of a past case database of each company. For example, when there is a specific harassment case or a tendency of a mental disorder for each industry such as a manufacturing industry, an IT industry, a medical industry, an education industry, or a service industry, an analysis model or an advice generation logic optimized for each industry can be applied. Specifically, the present privacy protection unit converts the consulter ID into an irreversible hash value using a secure hash algorithm. The present privacy protection unit automatically detects a personal name or a department name in text using a named entity recognition model and replaces it with a masking character. The present privacy protection unit receives raw consultation text as input data. The present privacy protection unit generates an anonymized text character string as output data. The present system adopts a multi-tenant architecture. The present system constructs a database schema logically separated for each company. The present system fine-tunes parameters of the generative AI using a company-specific data set. The present system efficiently constructs an industry-specific model using transfer learning. Thereby, the present system improves prediction accuracy of the model while mathematically guaranteeing data confidentiality. The present system realizes both enhancement of information security and customizability. The present system exhibits an extremely important technical effect in a use case of providing a secure and highly accurate support platform to companies in various industries.

Furthermore, for example, it is possible to cope with a case where the employee consults by voice input or in a chatbot format, and the generative AI can analyze the consultation content in real time using voice recognition or interactive natural language processing technology, and immediately return feedback. For example, even in a time zone when a person in charge is absent, such as at night or on a holiday, the generative AI automatically responds, thereby realizing an environment in which the employee can consult with peace of mind at any time. In addition, multilingual support is provided for foreign employees, and the generative AI performs automatic translation and multilingual emotion analysis, whereby consultation becomes possible across language barriers. For example, it copes with consultation in various languages such as English, Chinese, Korean, and Spanish, and automatically generates appropriate feedback and advice for each language. Specifically, the multilingual support unit executes a language determination model. The language determination model analyzes a character N-gram feature amount vector of input text. The language determination model generates a probability distribution of a language code as output data. The multilingual support unit specifies a language code having the highest probability. The multilingual support unit dynamically loads a neural machine translation model based on the specified language code. The machine translation model receives a text tensor of a foreign language as input data. The machine translation model generates a text tensor of a system standard language as output data. The system executes emotion analysis and case search on the translated text. The system translates the generated feedback into the original language again using the machine translation model. The system controls a real-time response of the chatbot using an asynchronous messaging queue. Thereby, the system realizes seamless data processing across language barriers. The system exhibits a remarkable technical effect in a use case of processing simultaneous accesses from various employees in a global company. The system significantly improves availability and scalability of the system.

Furthermore, trend analysis and statistical processing of the consultation content are also possible, and the generative AI can automatically analyze a company-wide harassment occurrence trend, a mental disorder occurrence rate for each department, a chronological change in the consultation content, an effectiveness evaluation of a recurrence prevention measure, and the like, and provide them as a dashboard or a report to a management team or the human resources department. For example, it is possible to provide information useful for grasping issues of the entire organization and planning measures, such as “Power harassment consultations in the sales department are on an increasing trend this month”, “The most frequent consultation content in the past half year was ‘overwork’”, and “The effect of a team building measure implemented as a recurrence prevention measure was high”. Specifically, the trend analysis unit executes a time-series data analysis model. The trend analysis unit acquires an average value of emotion scores and an appearance frequency of a specific keyword in a past certain period as a time-series array. The trend analysis unit predicts a future trend using an autoregressive integrated moving average model or a long short-term memory network. The trend analysis unit receives a monthly consultation number vector for the past 12 months as input data. The trend analysis unit generates a predicted number vector for the next three months as output data. The trend analysis unit automatically classifies the consultation content into a plurality of topics using a clustering algorithm. The trend analysis unit dimensionally compresses a high-dimensional analysis result into two-dimensional or three-dimensional coordinate data using principal component analysis. The trend analysis unit graphs the dimensionally compressed data using a data visualization library. The system converts a huge amount of unstructured data into structured statistical data. Thereby, the system quantitatively visualizes soundness of the organization. The system exhibits an extremely high technical effect in a use case of supporting data-driven management decisions. The system optimizes a calculation cost of data aggregation processing.

As described above, in the embodiment of the present invention, a user interface portion of the consultation receiving unit is realized on the terminal side, and main processing such as reception and recording of the consultation content, analysis by the generative AI, support destination guidance, appointment setting, report generation, a privacy protection function, and a trend analysis function is realized on the server side. The generative AI plays an indispensable role in overall core processing of the system, such as analysis of the consultation content, summary generation, emotion analysis, collation with past cases, advice generation, automatic report creation, trend analysis, statistical processing, and multilingual support. For example, when the employee inputs “Recently, reprimands from my boss have increased, and I feel depressed every day”, the generative AI extracts “excessive reprimand” and “feeling depressed”, refers to a past case of “mental disorder due to reprimand”, and automatically generates advice such as “an industrial physician interview and workload adjustment were effective”. Furthermore, for example, when “Ignoring from colleagues continues, and I am isolated in the workplace” is input, the generative AI extracts “ignoring” and “isolation”, refers to a past case of “mental disorder due to isolation”, and generates feedback such as “consultation with a consultation desk and a team building measure were effective”. Furthermore, it can cope with various usage scenes, such as “when a foreign employee consults in English, the generative AI analyzes the content in English and returns feedback in English”. Specifically, the system adopts a client-server type distributed processing model. The server dynamically distributes a load of inference processing to a plurality of calculation nodes. The system automates scaling of each processing module using container orchestration technology. The system adopts a microservice architecture to enhance independence of each function. The system controls communication between the modules via an API gateway. The system receives unstructured data in various formats as input data. The system generates an execution instruction of an optimized support action as output data. The system does not imitate a human mental process but quantifies semantic similarity of text by a mathematical operation in a high-dimensional vector space. Thereby, the system highly integrates specific rule-based processing and a machine learning model. The system dramatically improves processing efficiency and fault tolerance of the entire system. The system exhibits a remarkable technical effect in a use case of efficiently executing complex business logic as a physical operation inside a computer.

As described above, the embodiment of the present invention uses advanced natural language processing and emotion analysis technology with the generative AI as a core to analyze the consultation content of the employee from multiple angles and promptly, automatically presents an optimal support measure utilizing the past case database, and realizes cooperation with a support destination, automatic report generation, trend analysis, and multilingual support consistently as necessary, and is a system that greatly contributes to improvement of mental health of employees and improvement of ease of working of the entire company. Specifically, the system connects a plurality of neural network models as a pipeline. The system standardizes input and output of each model in a tensor format. The system eliminates a bottleneck of a data flow. The system applies zero-copy technology that minimizes data copy on a memory. The system reduces latency of inference processing to a millisecond unit. The system has expandability to integrally receive a time-series vector of biological information and attendance data of the employee as input data. The system calculates a health risk score of the entire organization as output data. The system is not merely a business efficiency improvement tool but realizes technical improvement of a data processing architecture itself. Thereby, the system efficiently manages huge computing resources and reduces an operation cost. The system exhibits an extremely important technical effect in a mission-critical personnel support use case requiring real-time data analysis and immediate feedback. The system directly contributes to progress of computer technology.

### System Configuration

The system according to the present embodiment includes a consultation receiving unit, an analysis unit, a support guidance unit, a database management unit, a privacy protection unit, a user interface unit, a report generation unit, an appointment management unit, a trend analysis unit, and a multilingual support unit.

The consultation receiving unit has a function of, when the employee accesses from a terminal such as a personal computer, a smartphone, a tablet, or a wearable device, receiving the consultation content, and recording the consultation content as a session log together with accompanying information such as time information, a consulter ID or an anonymous token, a terminal type, an IP address, position information, and a consultation category. For example, when the employee inputs “I am yelled at by my boss every day and feel mentally at my limit”, the consultation receiving unit receives this text data, adds an input date and time and terminal information, and transmits the text data to the server. In addition, in the case of voice input, voice recognition processing can be performed on the terminal side, and the voice input can be converted into text data and received. Furthermore, it copes with various input means such as sequential dialogue input in a chatbot format, image attachment, and file attachment, and can cope with a case such as “attaching a photograph of a slanderous sentence posted on a bulletin board in a workplace” or “transmitting past email exchanges as a file”. Specifically, the consultation receiving unit communicates with the terminal using an asynchronous communication protocol. The consultation receiving unit converts received image data into a multidimensional tensor of pixel values. The consultation receiving unit extracts a feature amount vector from an image using a convolutional neural network. The consultation receiving unit executes an optical character recognition algorithm. The consultation receiving unit detects a text region in the image as a bounding box. The consultation receiving unit extracts character string data from the detected region. The consultation receiving unit receives an image tensor having each RGB channel as input data. The consultation receiving unit generates an array of the extracted text character string and a reliability score as output data. The consultation receiving unit transfers the extracted text to a natural language processing pipeline. The system integrally processes multimodal data input on a single processing infrastructure. Thereby, the system improves efficiency of parsing processing for various data formats. The system exhibits a remarkable technical effect in a use case of accurately digitizing a complex consultation matter including an evidence image.

The analysis unit has a function of analyzing the received consultation content from multiple angles utilizing the generative AI. The analysis unit first extracts a characteristic keyword from a consultation sentence by a natural language processing model. For example, it extracts keywords such as “abusive language”, “ignoring”, “excessive reprimand”, “personality denial”, “overwork”, “isolation”, “backbiting”, “harassment”, “power harassment”, “sexual harassment”, “moral harassment”, “bullying”, “mental distress”, “poor physical condition”, “insomnia”, “palpitation”, “cannot stop crying”, and “difficulty in going to work”. Next, a summary of the entire consultation content is automatically generated by a summary generation model, and a summary sentence such as “Feeling a mental burden due to continuous abusive language and ignoring from the boss” or “Backbiting and harassment from colleagues continue, making it difficult to go to work” is output. Furthermore, a plurality of emotion parameters such as a negative emotion score, a stress index, an anxiety level, a depressive tendency, anger, sadness, fear, and a feeling of helplessness are digitized by an emotion analysis model, and for example, when there are many expressions such as “painful”, “suffering”, “at my limit”, “cannot sleep”, “want to die”, “impossible anymore”, and “no one helps me”, a high negative score is calculated. In addition, a similar case search model searches for a case having a keyword matching or similar to the consultation content from an in-house past personnel case database, and extracts a countermeasure such as “in a case where ‘ignoring’ and ‘abusive language’ occurred simultaneously in the past, an industrial physician interview and an investigation by the human resources department were conducted, and a reassignment for a certain period was performed”. Specific examples of a prompt sentence to be read by the generative AI include “Analyze the following employee consultation content, extract a main keyword, generate a summary sentence, calculate an emotion score, and present a countermeasure if there is a similar past case. Consultation content: ‘I am yelled at by my boss every day and feel mentally at my limit. I cannot consult with anyone, and days when I cannot sleep continue.’”. Specifically, the analysis unit executes a natural language processing model obtained by fine-tuning a pre-trained transformer model. The analysis unit receives a text array of a maximum of 1024 tokens as input data. The analysis unit generates a numerical vector indicating an extraction probability of each keyword as output data. The analysis unit optimizes a weight parameter of the model using a gradient descent method. The analysis unit controls a learning process so as to minimize a cross-entropy loss function. The analysis unit suppresses overlearning using a dropout method. The analysis unit applies batch normalization to improve a convergence speed of learning. The analysis unit controls an output of the generative AI using prompt engineering technology. The analysis unit includes an example of few-shot learning in the prompt. The system divides a complex natural language task into a plurality of subtasks and processes them in parallel. Thereby, the system significantly reduces calculation time of inference processing. The system dramatically improves prediction accuracy and generalization performance of the model. The system exhibits an extremely high technical effect in a use case of extracting a structured insight from unstructured text including various expressions.

The support guidance unit has a function of presenting optimal feedback and advice to the employee based on a determination result by the analysis unit and a countermeasure of a past case, specifying a support destination as necessary, and performing automatic setting of an appointment. For example, the generative AI automatically generates specific and situation-dependent advice, such as “Since there is a high possibility that the current situation is serious harassment, consultation with an industrial physician or the human resources department is recommended”, “In a similar past case, early consultation with a consultation desk was effective”, “First, prioritize physical condition management, and a leave of absence can be considered as necessary”, and “There is a case that improved by receiving counseling by an external counselor”, and displays the advice on a screen of the terminal. Furthermore, it searches for an open schedule of the industrial physician, automatically proposes a date and time when an interview is possible in the shortest time, and confirms a reservation by collating with convenience of the employee. For example, it displays guidance such as “An industrial physician interview is possible at 10:00 am next Tuesday. Do you want to confirm the reservation?”. When the appointment is confirmed, a detailed report including a summary of the consultation content, an extracted keyword, an emotion analysis result, a main point of the past case, recommended advice, and the like is automatically generated and provided to the support destination in advance. Specifically, the support guidance unit optimizes a feedback generation policy using a reinforcement learning model. The support guidance unit uses a feedback browsing time of the employee and a subsequent action history as a reward signal. The support guidance unit determines an optimal advice sequence based on a Markov decision process. The support guidance unit receives a current state vector as input data. The support guidance unit generates an action ID corresponding to a maximum value of an action value function as output data. The support guidance unit updates the action value function using a Q-learning algorithm. The support guidance unit controls a trade-off between exploration and exploitation by an epsilon-greedy method. The system implements a learning mechanism that dynamically adapts beyond static rule-based processing. Thereby, the system realizes individually optimized intervention for each user. The system continuously improves effectiveness of feedback. The system exhibits a remarkable technical effect in a use case of promoting behavioral change of the employee and increasing a success rate of problem solving.

The database management unit has a function of centrally managing various data handled in the entire system, such as consultation content, a session log, a past personnel case, support destination information, an appointment history, report data, trend analysis data, and multilingual support data. For example, a consultation history for each employee is managed in chronological order so that past consultation content and a response history can be promptly referred to. In the past personnel case database, consultation content, a countermeasure, a result, an involved support destination, a recurrence prevention measure, a period until resolution, a recurrence rate, employee satisfaction, presence or absence of follow-up, and the like are recorded. For example, a detailed case such as “In May 2023, employee A in the sales department consulted about ‘ignoring’ and ‘abusive language’, resolved by an industrial physician interview and reassignment, no recurrence” is stored. Specifically, the database management unit executes a distributed relational database system. The database management unit speeds up search processing using a B-tree index. The database management unit stores case data as graph structure data. The database management unit defines an employee and a support destination as nodes. The database management unit defines a consultation relationship and a response history as edges. The database management unit extracts a hidden relationship between nodes using a graph neural network. The database management unit receives an adjacency matrix and a feature amount matrix of a graph as input data. The database management unit generates an embedding vector of each node as output data. The system provides an architecture for efficiently storing and searching data having a complex relationship. Thereby, the system minimizes latency of data access. The system dramatically improves performance of complex query processing for a large-scale data set. The system exhibits an extremely important technical effect in a use case of analyzing an implicit human relationship network in an organization.

A privacy protection unit has a function of anonymizing personal information of an employee and preventing information leakage to the inside and outside of the system. For example, a consulter ID is converted into a random token, and information capable of identifying an individual is not included in consultation content or a report. Access logs and databases are also encrypted, and are designed so that personal information cannot be accessed even with administrator privileges. For example, in a report provided to a support destination, information is described in a format that cannot identify an individual, such as “Consulter: anonymous token 123456, Consultation content: abusive language and ignoring from boss, Emotion score: 0.92”. Specifically, the privacy protection unit executes an algorithm of differential privacy. The privacy protection unit adds noise following a Laplace distribution to output data. The privacy protection unit makes it mathematically difficult to identify an individual while maintaining statistical properties of the entire dataset. The privacy protection unit receives a result vector of an aggregation query as input data. The privacy protection unit generates a result vector to which noise is added as output data. The privacy protection unit executes a data operation in an encrypted state using homomorphic encryption technology. The system executes inference of a machine learning model without going through a decryption process. Thereby, the system completely eliminates a data leakage risk on a memory. The system solves a trade-off between security and data utilization by advanced mathematical processing. The system exhibits a remarkable technical effect in a use case of providing a secure data analysis platform in an enterprise environment where strict compliance requirements are demanded.

A user interface unit has a function of providing an intuitive input screen, a consultation history confirmation screen, a feedback and advice display screen, an appointment confirmation/change screen, a report viewing screen, and the like so that an employee can easily access the system from a terminal. For example, it realizes diverse user experiences such as sequential question answering in a chatbot format, voice input support, an image and file attachment function, a draft saving function for consultation content, a search function for past consultation history, and a feedback evaluation function. Specifically, the user interface unit is executed on a front-end server. The user interface unit communicates with the terminal using an asynchronous communication protocol. The user interface unit divides input text data into character-by-character tokens in real time. The user interface unit inputs the tokenized data into a natural language processing model. The natural language processing model adopts a transformer architecture. Input data to the natural language processing model is, for example, an embedding vector of text “I was yelled at by my boss”. The input data is expressed as a 512-dimensional floating-point number array. The natural language processing model extracts a contextual feature amount from the input data. The natural language processing model generates a next question sentence based on the extracted feature amount. Output data from the natural language processing model is, for example, a probability distribution vector of text “Since when has that situation been continuing?”. The output data has the number of dimensions equal to a vocabulary size. The user interface unit selects a token having the highest probability among the output data. The user interface unit combines the selected tokens to generate a response text. The user interface unit displays the generated response text on a chatbot screen. Thereby, the system shortens a response delay to the input of the employee to a millisecond unit. The system maintains continuity of a dialogue. The system reduces a psychological burden on the employee. The user interface unit receives voice input data. The user interface unit converts the voice input data into a mel-frequency cepstral coefficient. The user interface unit inputs the converted acoustic feature amount into a voice recognition neural network. The voice recognition neural network has a structure combining a convolutional neural network and a recurrent neural network. The voice recognition neural network outputs a posterior probability of a phoneme from the acoustic feature amount. The user interface unit estimates an optimal word sequence using a Viterbi search algorithm. The user interface unit saves the estimated word sequence as text data. Thereby, the system accurately receives a consultation from an employee in a situation where keyboard input is difficult. The system ensures diversity of input means. The user interface unit receives image data. The user interface unit resizes the image data and executes a normalization process. The user interface unit inputs the normalized image tensor into an image recognition model. The image recognition model has a residual network structure. The image recognition model extracts a visual feature amount from the image tensor. The image recognition model recognizes text and an object in the image based on the extracted feature amount. The user interface unit stores a recognition result in a database as supplementary information of the consultation content. Thereby, the system efficiently manages unstructured data such as an evidence image. The system enhances objectivity of the consultation content.

A report generation unit has a function of automatically generating a detailed report including a summary of consultation content, an extracted keyword, an analysis result of emotion, a main point of a past case, recommended advice, appointment information, a follow-up proposal, and the like, and providing the detailed report to a support destination and an administrator. For example, information enabling the support destination to respond quickly and accurately is comprehensively described, such as “The consulter has consulted three times in the past two weeks, and the negative emotion score is on an upward trend” and “In a similar past case, an industrial physician interview and workload adjustment were effective, so a similar response is recommended”. Specifically, the report generation unit collects information from a plurality of data sources. The report generation unit integrates the collected information to generate structured data. The report generation unit inputs the structured data into a large language model. The large language model adopts a transformer architecture equipped with a self-attention mechanism. Input data to the large language model is, for example, a prompt character string including a summary text of the consultation content, a list of extracted keywords, a score vector of emotion analysis, and a main point text of the past case. The input data is tokenized and expressed as a high-dimensional tensor to which positional encoding is added. The large language model processes the input tensor with a multi-layer self-attention layer. The large language model calculates a dependency relationship between respective tokens. The large language model generates a component of the report based on a calculation result. Output data from the large language model is, for example, a token sequence of text “The consulter has consulted three times in the past two weeks, and the negative emotion score is on an upward trend”. The output data is output as a vector group indicating a generation probability of each token. The report generation unit determines an optimal token sequence using a beam search algorithm. The report generation unit combines the determined token sequences to generate a natural language report text. The report generation unit converts the generated report text into an HTML format or PDF format document. The report generation unit encrypts the converted document. The report generation unit transmits the encrypted document to a terminal of the support destination. Thereby, the system completely eliminates time for a human to manually create a report. The system unifies a format of the report. The system speeds up information transmission to the support destination. The report generation unit graphs a time-series change of the emotion analysis result. The report generation unit generates graph image data. The report generation unit embeds the graph image data in the report. Thereby, the system visually presents a change in a psychological state of the consulter. The system facilitates grasping of a situation by the support destination. The large language model has learned a large amount of personnel and labor-related documents in pre-training. The large language model has learned model report data created by an expert in fine-tuning. The large language model optimizes a weight parameter using a cross-entropy error function. Thereby, the system generates a report using professional and appropriate expressions. The system improves quality of the report.

An appointment management unit has a function of managing a schedule of a support destination such as an industrial physician, a human resources department, a consultation desk, or an external counselor, automatically proposing an optimal interview date and time according to a wish and a situation of an employee, and performing confirmation, change, cancellation, reminder notification, and the like of a reservation. For example, it provides guidance such as “An interview with an external counselor is possible at 2:00 PM next Wednesday” and “If you want to change the reservation date and time, please select your desired date and time from here”. Specifically, the appointment management unit accesses a schedule database of the support destination. The appointment management unit acquires a list of free time slots from the schedule database. The appointment management unit acquires a desired condition of the employee. The appointment management unit inputs the list of free time slots and the desired condition into a matching algorithm. The matching algorithm functions as a solver for a constraint satisfaction problem. Input data to the matching algorithm is, for example, a binary matrix indicating free time of the support destination and a binary vector indicating a desired time zone of the employee. The input data is expressed as numerical data indicating availability for each time slot. The matching algorithm calculates a list of candidate dates and times satisfying the condition based on the input data. Output data from the matching algorithm is, for example, a timestamp array of a date and time “2:00 PM next Wednesday”. The output data is output as structured data to which a priority score is assigned. The appointment management unit selects a date and time having the highest priority score. The appointment management unit converts the selected date and time into a proposal text. The appointment management unit transmits the proposal text to a terminal of the employee. Thereby, the system reduces the number of round trips of communication required for interview adjustment. The system dramatically improves efficiency of schedule adjustment. The appointment management unit receives a reservation confirmation request from the employee. The appointment management unit updates a corresponding time slot in the schedule database to reserved. The appointment management unit encrypts and saves reservation information. The appointment management unit executes a reminder process a certain time before the reservation date and time. The appointment management unit generates a reminder notification. The appointment management unit transmits the reminder notification to the terminal of the employee and the support destination. Thereby, the system prevents cancellation and lateness of the interview. The system enhances certainty of support work. The appointment management unit cooperates with an urgency determination module. The urgency determination module determines urgency based on an emotion score of consultation content. When it is determined that the urgency is high, the appointment management unit ignores a normal schedule constraint and forcibly secures the shortest free time slot. Thereby, the system realizes rapid intervention for a serious case. The system contributes to ensuring safety of the employee.

A trend analysis unit has a function of automatically analyzing a company-wide harassment occurrence trend, a mental disorder occurrence rate for each department, a time-series change in consultation content, an effectiveness evaluation of a recurrence prevention measure, and the like, and providing them as a dashboard or a report to a management layer or a human resources department. For example, it can provide information useful for grasping issues of the entire organization and planning measures, such as “Power harassment consultations in the sales department are on an upward trend this month”, “The most frequent consultation content in the past half year was ‘overwork’”, and “A team building measure implemented as a recurrence prevention measure was highly effective”. Specifically, the trend analysis unit extracts consultation log data for a certain past period from a database. The trend analysis unit preprocesses the extracted consultation log data. The trend analysis unit inputs the preprocessed data into a clustering algorithm. The clustering algorithm adopts K-means or DBSCAN. Input data to the clustering algorithm is, for example, a feature amount vector group extracted from each consultation content. The input data is expressed as a set of 768-dimensional floating-point number arrays. The clustering algorithm calculates a cosine similarity between feature amount vectors. The clustering algorithm classifies vectors having high similarity into the same cluster. Output data from the clustering algorithm is an array of cluster IDs for each consultation data. The output data includes center vector information of each cluster. The trend analysis unit aggregates attribute information of consultation data belonging to each cluster. The trend analysis unit calculates a harassment occurrence rate for each department and an appearance frequency of a specific keyword based on an aggregation result. The trend analysis unit organizes a calculation result as time-series data. The trend analysis unit inputs the time-series data into an anomaly detection model. The anomaly detection model adopts a long short-term memory network. Input data to the anomaly detection model is, for example, a time-series array of the number of monthly consultations and an average emotion score for the past 12 months. The anomaly detection model predicts a future trend from the input data. The anomaly detection model calculates a degree of divergence between a predicted value and an actual value. Output data from the anomaly detection model is an array of anomaly scores at each time point. When the anomaly score exceeds a preset threshold value, the trend analysis unit generates alert information. The trend analysis unit renders the aggregation result and the alert information as a visual dashboard screen. The trend analysis unit transmits the dashboard screen to a terminal of an administrator. Thereby, the system discovers a potential problem in the organization at an early stage. The system supports data-driven personnel measure planning. The system provides an objective decision-making material to the management layer. The trend analysis unit compares data before and after implementation of a measure. The trend analysis unit executes a statistical hypothesis test. The trend analysis unit quantitatively evaluates effectiveness of the measure. Thereby, the system enables continuous improvement of the recurrence prevention measure.

A multilingual support unit has a function of realizing consultation receiving, analysis, feedback, and report generation in multiple languages for a foreign employee. Generative AI performs automatic translation and multilingual emotion analysis, responds to consultations in diverse languages such as English, Chinese, Korean, and Spanish, for example, and automatically generates appropriate feedback and advice for each language. For example, by using an English prompt such as “Please describe your workplace issue in detail. The system will analyze your input and provide advice.” or a Chinese prompt such as “ [symbol] [symbol] [symbol] , [symbol] [symbol] ”, it is possible to respond to diverse language environments. Specifically, the multilingual support unit automatically determines a language of input text data. The multilingual support unit executes a language determination model. The language determination model is a classifier based on an N-gram feature amount of characters. The multilingual support unit acquires a determined language code. The multilingual support unit inputs the input text and the determined language code into a machine translation model. The machine translation model is a neural network having an encoder-decoder structure. Input data to the machine translation model is, for example, a token sequence of Japanese text “I was yelled at by my boss”. The input data is expressed as an embedding vector of each token. The machine translation model converts the input data into an intermediate representation vector. The machine translation model generates a token sequence of a target language from the intermediate representation vector. Output data from the machine translation model is, for example, a token sequence of English text “I was yelled at by my boss”. The output data is output as a generation probability distribution of each token. The multilingual support unit inputs the translated text into an analysis unit. The analysis unit executes natural language processing in a common language space. The multilingual support unit retranslates an analysis result and generated advice into the original language. The multilingual support unit transmits the retranslated text to a terminal. Thereby, the system provides homogeneous support across language barriers. The system enables operation in a company having multinational employees. The multilingual support unit executes a multilingual emotion analysis model. The multilingual emotion analysis model is based on a multilingual pre-trained model. The multilingual emotion analysis model calculates an emotion score in consideration of expressions and nuances peculiar to each language. Input data to the multilingual emotion analysis model is, for example, an embedding vector of a Chinese consultation text. Output data from the multilingual emotion analysis model is a floating-point number from 0 to 1 indicating an intensity of a negative emotion. The multilingual support unit holds a prompt template in consideration of a cultural background for each language. The multilingual support unit selects an appropriate prompt template according to the language code. The multilingual support unit constructs an input prompt to the generative AI using the selected template. Thereby, the system generates natural and appropriate feedback for a native speaker of each language. The system lowers a psychological hurdle for a foreign employee to use the system.

As described above, the system according to the present embodiment realizes everything from consultation receiving of an employee to analysis, support guidance, data management, privacy protection, a user interface, report generation, appointment management, trend analysis, and multilingual support in an integrated manner by cooperation of respective units, and greatly contributes to improvement of mental health of the employee and improvement of ease of working of the entire company by utilizing advanced natural language processing and emotion analysis technology with generative AI as a core. Specifically, the system has a configuration in which a plurality of independent modules cooperate on a microservice architecture. The system uses a RESTful API or gRPC for communication between the respective modules. The system dynamically allocates computing resources according to a load of each module using a container orchestration tool. The system offloads inference processing of the generative AI to a dedicated GPU cluster. The system maximizes throughput by parallelizing the inference processing. The system executes batch processing of input data. The system optimizes utilization efficiency of a memory bandwidth. Thereby, the system maintains stable response performance even for simultaneous access from tens of thousands of employees. The system ensures scalability in a large-scale enterprise environment. The system periodically updates a weight parameter of a natural language processing model. The system continuously learns data of a new consultation case and a personnel measure. The system improves quality of feedback using a reinforcement learning algorithm. The system uses an evaluation score from the employee as a reward signal. The system optimizes a policy of a model so as to maximize a reward. Thereby, the system functions as a self-evolving system in which accuracy and appropriateness of an answer improve as an operation period becomes longer. The system goes beyond mere automation of routine work and realizes advanced judgment ability equal to or higher than that of a human expert on a computer. The system enables early discovery and intervention of a mental disorder of the employee. The system quantitatively reduces a risk of a leave of absence or turnover. The system prevents a decline in labor productivity of the entire company. The system provides a data-driven health management platform that becomes a foundation of human capital management. The system implements homomorphic encryption and differential privacy as privacy protection technology. The system executes arithmetic processing while highly confidential personal information remains encrypted. Thereby, the system mathematically eliminates a risk of information leakage. The system constructs a secure environment that the employee can use with peace of mind.

### Implementation Steps

Step 1: Input and Receiving of Consultation Content An employee accesses the system from a terminal such as a personal computer, a smartphone, a tablet, or a wearable device using a dedicated application, a web browser, a chatbot, a voice input interface, or the like, and inputs consultation content in a free description format. For example, specific worries and situations can be input, such as “I am yelled at by my boss every day and feel mentally at my limit”, “I am ignored by my colleagues and isolated”, “The amount of work is too much and I am about to get sick, but I cannot consult anyone”, or “Backbiting and harassment at the workplace continue, and I am afraid to go to work”. In the case of voice input, voice recognition processing is performed on the terminal side, converted into text data, and transmitted to a server. A consultation receiving unit records the input consultation content as a session log together with accompanying information such as time information, a consulter ID or an anonymous token, a terminal type, an IP address, position information, and a consultation category. Specifically, in this step, the terminal draws a user interface on a screen. The terminal detects an input operation from the employee with an event listener. The terminal temporarily saves the input text data in a buffer on a memory. The terminal executes an input sanitization process on the input data. The terminal removes a malicious script and an invalid character code. When voice input is selected, the terminal activates a microphone device. The terminal acquires voice waveform data at a sampling rate of 16 kHz. The terminal encodes the voice waveform data as pulse code modulation data. The terminal transmits the encoded voice data to a voice recognition API. The terminal receives text data from the voice recognition API. The terminal reflects the text data in an input field. The terminal detects a press event of a transmission button. The terminal packages the input text data and the accompanying information into a payload in a JSON format. The terminal encrypts the payload using a TLS protocol. The terminal transmits the encrypted payload to the server as an HTTPS POST request. The consultation receiving unit of the server receives the request. The consultation receiving unit decrypts the payload. The consultation receiving unit verifies data in the payload. The consultation receiving unit inputs the consulter ID into a hash function. The consultation receiving unit generates a one-way hash value. The consultation receiving unit uses the hash value as an anonymous token. The consultation receiving unit acquires a timestamp of a current time. The consultation receiving unit estimates a geographical location from the IP address. The consultation receiving unit generates such information as a structured session log object. The consultation receiving unit inserts the session log object into a relational database. Thereby, the system guarantees integrity and confidentiality of the input data. The system reliably collects metadata necessary for subsequent analysis processing. The system includes a retry mechanism against network delay and disconnection. The system prevents data loss.

Step 2: Analysis of Consultation Content by Generative AI An analysis unit on a server side utilizes generative AI to analyze received consultation content from multiple angles. First, a characteristic keyword is extracted from a consultation sentence by a natural language processing model, and keywords such as “abusive language”, “ignoring”, “excessive reprimand”, “personality denial”, “overwork”, “isolation”, “backbiting”, “harassment”, “power harassment”, “sexual harassment”, “moral harassment”, “bullying”, “mental distress”, “poor physical condition”, “insomnia”, “palpitations”, “cannot stop crying”, and “difficulty going to work” are extracted, for example. Next, a summary of the entire consultation content is automatically generated by a summary generation model, and a summary sentence such as “Feeling a mental burden due to continuous abusive language and ignoring from the boss” or “Backbiting and harassment from colleagues continue, making it difficult to go to work” is output, for example. Furthermore, a plurality of emotion parameters such as a negative emotion score, a stress index, an anxiety level, a depressive tendency, anger, sadness, fear, and a sense of helplessness are digitized by an emotion analysis model. As a specific example of a prompt sentence to be read by the generative AI, “Analyze the following employee consultation content, extract a main keyword, generate a summary sentence, and calculate an emotion score. Consultation content: ‘I am yelled at by my boss every day and feel mentally at my limit. I cannot consult anyone, and days when I cannot sleep continue.’” and the like can be cited. Specifically, in this step, the analysis unit reads a session log object from a database. The analysis unit extracts consultation content text. The analysis unit inputs the consultation content text into a morphological analysis engine. The morphological analysis engine divides the text into word tokens. The analysis unit subjects the word tokens to a stop word filtering process. The analysis unit removes unnecessary particles and symbols. The analysis unit inputs the preprocessed token sequence into the natural language processing model. The natural language processing model adopts a BERT architecture. Input data to the natural language processing model is, for example, an embedding vector sequence of tokens such as “boss”, “every day”, “yell”, and “limit”. The input data is a tensor in which each token is expressed as a 768-dimensional vector. The natural language processing model calculates a contextual relationship between tokens using a self-attention mechanism. The natural language processing model calculates an importance score of each token. Output data from the natural language processing model is an array of importance scores for each token. The analysis unit extracts a token whose importance score exceeds a threshold value as a keyword. The analysis unit lists the extracted keywords. The analysis unit inputs the consultation content text into the summary generation model. The summary generation model adopts a BART architecture. Input data to the summary generation model is a token sequence of the entire consultation content text. The summary generation model generates a latent representation of the input text with an encoder. The summary generation model autoregressively generates a token of a summary text from the latent representation with a decoder. Output data from the summary generation model is, for example, a token sequence of a summary text “mental limit due to abusive language from boss”. The analysis unit inputs the consultation content text into the emotion analysis model. The emotion analysis model is a neural network having a multilayer perceptron as a classifier. Input data to the emotion analysis model is a sentence embedding vector of the consultation content text. Output data from the emotion analysis model is a softmax probability distribution for each emotion class such as negative, positive, and neutral. The output data takes a format of a numerical vector such as a negative emotion score of 0.85 and a stress index of 0.78, for example. The analysis unit integrates these analysis results to generate an analysis result object. Thereby, the system converts natural language text, which is unstructured data, into structured data processable by a computer. The system calculates an objective index that does not depend on human subjectivity. The system dramatically improves accuracy of subsequent similar case search and advice generation.

Step 3: Collation with Past Case Database and Extraction of Similar Case The analysis unit searches for a case having a keyword matching or similar to the consultation content by referring to a past personnel case database accumulated in a company, using a similar case search model of generative AI. For example, it automatically extracts a similar case and a countermeasure thereof, such as “in a past case where ‘ignoring’ and ‘abusive language’ occurred simultaneously, an interview with an industrial physician and an investigation by a human resources department were conducted, and a reassignment for a certain period was performed” or “in a case where ‘backbiting’ and ‘harassment’ continued, counseling by an external counselor and a team building measure were effective”. A specific example of a prompt sentence to be read by the generative AI includes “Search the database for a past case similar to the following consultation content and keywords, and summarize a countermeasure and a result. Consultation content: ‘I am ignored by my colleagues and isolated.’ Keywords: ‘ignoring’, ‘isolation’”. Specifically, in this step, the analysis unit acquires the extracted keyword list and summary text. The analysis unit inputs these into a query vector generation module. The query vector generation module converts the text data into a fixed-length dense vector. Output data from the query vector generation module is, for example, a 512-dimensional query vector. The analysis unit accesses the past personnel case database. This database is a vector database in which past case texts are vectorized in advance and stored. The analysis unit executes an approximate nearest neighbor search algorithm between the query vector and each case vector in the database. The approximate nearest neighbor search algorithm uses an HNSW index. Input data to the algorithm is the query vector and a group of tens of thousands of case vectors in the database. The algorithm calculates a cosine similarity or a Euclidean distance between vectors in a high-dimensional space at high speed. Output data from the algorithm is a list of top N case IDs having the highest similarity scores. The output data includes the similarity score of each case. The analysis unit acquires detailed data of the case from a relational database based on the extracted case ID. The detailed data includes an outline of the event, the implemented countermeasure, and a result thereof. The analysis unit inputs the acquired detailed data into the generative AI. The generative AI is a large language model. Input data to the generative AI is, for example, a prompt character string “Consultation content: I am ignored by my colleagues and isolated. Past case 1: Reassignment was implemented for an isolation case due to ignoring, resulting in improvement. Past case 2: External counseling was implemented, resulting in improvement.” The generative AI analyzes a context of the input prompt. The generative AI generates a summary text of a countermeasure most suitable for the current consultation content. Output data from the generative AI is, for example, text data “In a past similar case, counseling by an external counselor and a team building measure were effective”. Thereby, the system eliminates the time for a human to manually search from a huge amount of accumulated past data. Since the system performs a search based on semantic similarity in a high-dimensional vector space, it realizes case extraction with higher accuracy than a simple keyword matching search. The system enables data-driven countermeasure planning based on past successful cases.

Step 4: Automatic Generation and Presentation of Feedback and Advice The support guidance unit automatically generates optimal feedback and advice for the employee by the generative AI based on a determination result by the analysis unit and the countermeasure of the past case, and presents the feedback and the advice on a screen of the terminal. For example, it presents specific and situation-dependent advice, such as “Since there is a high possibility that the current situation is serious harassment, consultation with an industrial physician or a human resources department is recommended”, “In a past similar case, early consultation with a consultation desk was effective”, or “First, prioritize physical condition management, and taking a leave of absence can also be considered as necessary”. A specific example of a prompt sentence to be read by the generative AI includes “Generate optimal feedback and advice for the employee based on the following consultation content, emotion score, and past case information. Consultation content: ‘The amount of work is too much and I am about to get sick, but I cannot consult anyone.’ Emotion score: 0.85 Past case: ‘Workload adjustment and an interview with an industrial physician were effective’”. Specifically, in this step, the support guidance unit acquires an analysis result object and countermeasure data of a similar case. The support guidance unit integrates these data and embeds them in a prompt template. The support guidance unit inputs the constructed prompt into the generative AI. The generative AI is a large language model running on a GPU server dedicated to inference. Input data to the generative AI is a long character string including, for example, consultation content text, an emotion score vector, an extracted keyword list, and countermeasure text of a past case. The input data is converted into an integer index array by a tokenizer. The generative AI calculates an appearance probability of a next token using a decoder block of a transformer. The generative AI generates diverse and appropriate text by applying hyperparameters such as a temperature parameter and top-p sampling. Output data from the generative AI is text data constituting specific feedback and advice for the employee. The output data takes a form of a sentence such as “Since there is a high possibility that the current situation is serious harassment, consultation with an industrial physician is recommended”, for example. The support guidance unit receives the generated text data. The support guidance unit executes a filtering process of inappropriate expressions on the text data. The support guidance unit stores the filtered text data in a response payload in a JSON format. The support guidance unit transmits the response payload to the terminal. The terminal receives the response payload. The terminal parses the text data in the payload. The terminal renders the text data in a designated area of a user interface. The terminal performs visual decoration such as highlighting or adding an icon according to the content of the advice. Thereby, the system provides advice completely customized to the individual situation of the employee in real time. The system realizes a high degree of personalization different from a uniform manual response. Since the system generates advice based on a quantitative index such as an emotion score, it ensures persuasiveness and objectivity. The system presents a specific path for the employee to take a next action, and promotes problem solving.

Step 5: Specification of Support Destination and Automatic Setting of Appointment When the employee desires or when the system determines it necessary, the support guidance unit automatically specifies a support destination such as an industrial physician, a human resources department, a consultation desk, or an external counselor, and an appointment management unit searches a schedule of the support destination, automatically proposes the earliest possible date and time for an interview, and confirms a reservation by collating with the convenience of the employee. For example, it displays a guidance such as “An interview with an industrial physician is possible at 10:00 am next Tuesday. Do you want to confirm the reservation?”, and also performs a reminder notification when the reservation is confirmed. Specifically, in this step, the support guidance unit extracts a category of a recommended support destination from the generated advice content. The support guidance unit transmits the extracted category to the appointment management unit. The appointment management unit issues a query to a support destination database. The appointment management unit acquires a list of support destinations of the corresponding category. The appointment management unit calls a calendar API of each support destination. The appointment management unit acquires available time slot data for the next two weeks in a JSON format. The appointment management unit calls a calendar API of the employee. The appointment management unit acquires schedule data of the employee. The appointment management unit inputs the available time slot of the support destination and the schedule data of the employee into a comparison calculation module. The comparison calculation module calculates a logical product of both. Input data to the comparison calculation module is, for example, a binary array expressing a time slot in units of 30 minutes as a bit string. Output data from the comparison calculation module is a bit string indicating a time slot in which both are available. The appointment management unit specifies a time slot of the closest date and time from the output bit string. The appointment management unit formats the specified date and time as a proposal message. The appointment management unit transmits the proposal message to the terminal. The terminal displays the proposal message as a pop-up on the screen. The terminal receives an input operation of approval or change from the employee. The terminal transmits an input result to the server. When receiving the approval, the appointment management unit transmits a POST request for reservation confirmation to the calendar API. The appointment management unit generates a reservation ID. The appointment management unit saves the reservation ID in the database. The appointment management unit registers an asynchronous task triggered 24 hours and 1 hour before the reservation date and time in a scheduler. The asynchronous task generates a push notification payload upon execution. The asynchronous task transmits the push notification payload to the terminal. Thereby, the system completely automates complicated schedule adjustment work that a human has performed by telephone or email. The system shortens a lead time required for adjustment from several days to several seconds. The system prevents an opportunity loss of an interview. The system accelerates the progress of the entire support process.

Step 6: Automatic Generation of Report and Advance Provision to Support Destination A report generation unit automatically generates a detailed report including a summary of the consultation content, an extracted keyword, an emotion analysis result, a main point of a past case, recommended advice, appointment information, a follow-up proposal, and the like by the generative AI, and provides the report to the support destination or an administrator. For example, information enabling the support destination to respond quickly and accurately is comprehensively described, such as “The consulter has consulted three times in the past two weeks, and the negative emotion score is on an upward trend” or “Since an interview with an industrial physician and workload adjustment were effective in a past similar case, a similar response is recommended”. A specific example of a prompt sentence to be read by the generative AI includes “Create a detailed report for a support destination based on the following consultation content, emotion score, past case, and advice information.” Specifically, in this step, the report generation unit collects all data related to the session from the database. The report generation unit loads the consultation content text, the extracted keyword list, the emotion score vector, the similar case data, the generated advice, and the confirmed appointment information onto a memory. The report generation unit integrates these data into a structured JSON object. The report generation unit converts the JSON object into a prompt character string to be input into a large language model. The prompt character string takes a format in which each data item is enclosed by a specific tag. The report generation unit inputs the prompt character string into the large language model. The large language model is an instruction-tuned transformer model. Input data to the large language model is long context data extending to, for example, thousands of tokens. The large language model analyzes a relevance of each piece of information in the input data by a self-attention mechanism. The large language model generates a logical report text for the support destination to quickly grasp the situation. Output data from the large language model is text data in a markdown format including a heading, bullet points, and a summary paragraph. The output data includes an analysis result such as “The negative emotion score is as high as 0.85, requiring an urgent response”, for example. The report generation unit inputs the text data in the markdown format into an HTML parser. The report generation unit generates an HTML document. The report generation unit inputs the HTML document into a PDF conversion engine. The report generation unit generates a report file in a PDF format. The report generation unit encrypts the report file with an AES256 algorithm. The report generation unit saves the encrypted report file in a secure file server. The report generation unit generates a notification email including an access link to the file. The report generation unit transmits the notification email to an address of the support destination. Thereby, the system enables the support destination to grasp the situation of the consulter in detail and objectively before the interview. The system significantly reduces a hearing time during the interview. The system simultaneously improves the quality and efficiency of support. The system eliminates an omission of information transmission and a bias due to subjective interpretation.

Step 7: Privacy Protection Process and Data Management A privacy protection unit anonymizes personal information of the employee, and prevents information leakage to the inside and outside of the system. For example, it converts a consulter ID into a random token, and prevents information capable of identifying an individual from being included in the consultation content or the report. A database management unit centrally manages various data handled in the entire system, such as consultation content, a session log, a past personnel case, support destination information, an appointment history, report data, trend analysis data, and multilingual support data, and thoroughly implements access authority and an encryption process. Specifically, in this step, the privacy protection unit executes a named entity extraction model on the input text data. The named entity extraction model is a conditional random field or a BERT-based classifier. Input data to the named entity extraction model is a text token sequence of the consultation content. The named entity extraction model calculates a probability of whether each token corresponds to personal information such as a person's name, an organization name, or a place name. Output data from the named entity extraction model is an array of labels for each token. The privacy protection unit replaces the token determined to be personal information with a masking character string or a dummy token. The privacy protection unit generates anonymized text data by a replacement process. The privacy protection unit inputs the consulter ID into a hash function with salt. The privacy protection unit generates an irreversible anonymous token. The database management unit associates the anonymized text data with the anonymous token and saves them in the database. The database management unit runs on a relational database management system. The database management unit applies transparent data encryption to all saved data. The database management unit cooperates with an encryption key management system. The database management unit periodically rotates an encryption key. The database management unit evaluates an access control list based on a role of each user. The database management unit blocks a query from an unauthorized user. The database management unit records all access histories as an audit log. The audit log is saved in a blockchain or an append-only storage to prevent falsification. Thereby, the system strongly protects extremely sensitive personal information of the employee. The system minimizes an information leakage risk due to internal fraud or an external cyber attack. The system technically ensures an environment in which the employee can consult with peace of mind without fearing retaliation or disadvantageous treatment. The system realizes an operation compliant with various compliance requirements and data protection regulations.

Step 8: Trend Analysis, Multilingual Support, and Company-wide Utilization A trend analysis unit automatically analyzes a company-wide harassment occurrence trend, a mental disorder occurrence rate for each department, a time-series change in consultation content, an effectiveness evaluation of a recurrence prevention measure, and the like, and provides them to a management layer or a human resources department as a dashboard or a report. A multilingual support unit realizes consultation reception, analysis, feedback, and report generation in multiple languages for foreign employees, and the generative AI performs automatic translation and multilingual emotion analysis. For example, by using an English prompt such as “Please describe your workplace issue in detail. The system will analyze your input and provide advice.” or a Chinese prompt such as “ [symbol] [symbol] , [symbol] [symbol] [symbol] ”, it is possible to support diverse language environments. Specifically, in this step, the trend analysis unit extracts anonymized consultation log data from the database by batch processing. The trend analysis unit loads the extracted data into a multidimensional online analytical processing cube. The trend analysis unit aggregates the data in a plurality of dimensions such as a department, a job title, and a time axis. The trend analysis unit inputs the aggregated data into a machine learning-based time-series prediction model. The time-series prediction model adopts an ARIMA model or a Prophet algorithm. Input data to the time-series prediction model is a numerical array of the number of past monthly harassment consultations. Output data from the time-series prediction model is numerical data of the predicted number of cases and a confidence interval for the next six months. The trend analysis unit draws these analysis results as a graph or a heat map using a data visualization library. The trend analysis unit arranges the drawn components on a dashboard screen. The trend analysis unit distributes the dashboard screen to a terminal of the management layer. The multilingual support unit acquires a language code based on an OS setting of the terminal or an explicit selection by a user. The multilingual support unit dynamically switches a display language of a user interface according to the language code. The multilingual support unit inputs the input foreign language text data into a machine translation API. Input data to the machine translation API is, for example, a Chinese character string. Output data from the machine translation API is a translated Japanese character string. The system executes a subsequent analysis process using the translated Japanese text. The system inputs the generated Japanese advice text into the machine translation API again. Output data from the machine translation API is a translated Chinese character string. The multilingual support unit transmits this Chinese character string to the terminal. Thereby, the system provides a means for quantitatively grasping a health condition of the entire organization from a macro perspective. The system supports the management layer in taking a preventive measure based on data. The system eliminates a language barrier and provides a fair and homogeneous support service to all employees. The system technically promotes a diversity inclusion initiative in a global company.

### Specific Use Case

For example, when an employee feels that he/se is receiving a plurality of harassing acts such as continuous reprimands and abusive language from a boss, and further ignoring and backbiting from colleagues in a workplace, and is aware of a sign of a mental disorder such as a mental burden, insomnia, or difficulty in going to work, the employee accesses the employee support system of the present invention from a terminal such as a personal computer or a smartphone, and inputs consultation content in a free description format, such as “I am yelled at by my boss every day, and ignored by my colleagues as well. Recently, there have been days when I cannot sleep, and I am afraid to go to work. I cannot consult anyone, and I do not know what to do.”, on an input screen of the consultation receiving unit. The consultation receiving unit receives the input content, and records it as a session log in a server together with accompanying information such as an input date and time, a terminal type, and a consulter ID or an anonymous token. Specifically, in this specific example, the employee activates a web browser of the terminal. The terminal connects to a front-end server of the system via an HTTPS protocol. The terminal executes single sign-on authentication. The terminal acquires an authentication token. The terminal renders an input form screen of the consultation receiving unit. The terminal acquires character string data input by the employee from a keyboard or a software keyboard in real time. The terminal stores the input character string data “I am yelled at by my boss every day, and ignored by my colleagues as well. Recently, there have been days when I cannot sleep, and I am afraid to go to work. I cannot consult anyone, and I do not know what to do.” in a variable on a memory. The terminal detects a click event of a transmission button. The terminal generates a JSON object including the character string data, a UNIX timestamp of a current time, a user agent character string of the terminal, and the authentication token. The terminal serializes the JSON object. The terminal transmits the serialized data to an endpoint of the server as a payload of an AJAX request. The consultation receiving unit of the server receives the request. The consultation receiving unit verifies the authentication token. The consultation receiving unit extracts each data field from the payload. The consultation receiving unit maps the extracted data to each column of a session log table. The consultation receiving unit generates an INSERT statement of SQL. The consultation receiving unit executes a query to a database engine. The database engine writes the data to a persistent storage. The database engine returns a status of write completion. The consultation receiving unit confirms the status and records a success of the process in a log. Thereby, the system reliably and safely takes unstructured text data, which is a raw voice of the employee, into the system together with accompanying metadata. The system prepares input data for subsequent advanced AI analysis. The system keeps responsiveness of an input interface high, and provides smooth operability that does not give stress to an employee in a mentally unstable state.

The analysis unit analyzes the consultation content using the generative AI. First, the natural language processing model extracts a characteristic keyword such as “abusive language”, “ignoring”, “difficulty in going to work”, “cannot sleep”, or “mental burden”, and the summary generation model automatically generates a summary sentence such as “A mental burden increases due to continuous abusive language from a boss and ignoring from colleagues, resulting in a state of insomnia and difficulty in going to work”. The emotion analysis model calculates a high negative emotion score (for example, 0.92) from an expression such as “painful”, “afraid”, or “cannot sleep”, and a stress index and a depressive tendency also show high values. A specific example of a prompt sentence to be read by the generative AI includes “Analyze the following employee consultation content, extract a main keyword, generate a summary sentence, and calculate an emotion score. Consultation content: ‘I am yelled at by my boss every day, and ignored by my colleagues as well. Recently, there have been days when I cannot sleep, and I am afraid to go to work. I cannot consult anyone, and I do not know what to do.’” Specifically, in this specific example, the analysis unit reads the saved consultation content text from the database. The analysis unit inputs the consultation content text into the natural language processing model. The natural language processing model is a pre-trained transformer encoder. Input data to the natural language processing model is an array of token IDs obtained by dividing text “I am yelled at by my boss every day” into subword units. The input data is expressed as an integer array having a length of 50, for example. The natural language processing model calculates an embedding vector of each token. The natural language processing model outputs a feature vector considering a context by a self-attention mechanism. The analysis unit inputs the feature vector into a classification layer for keyword extraction. The classification layer outputs a probability that each token is a keyword. The analysis unit extracts a token whose probability exceeds a threshold, and generates a character string list of “abusive language”, “ignoring”, “difficulty in going to work”, “cannot sleep”, and “mental burden”. The analysis unit inputs the consultation content text into the summary generation model. The summary generation model has an encoder-decoder structure. The summary generation model sequentially generates a token of a summary sentence from a latent representation of the input text. Output data from the summary generation model is a text character string “A mental burden increases due to continuous abusive language from a boss and ignoring from colleagues, resulting in a state of insomnia and difficulty in going to work”. The analysis unit inputs the consultation content text into the emotion analysis model. The emotion analysis model inputs a feature vector of the entire text into a fully connected layer. The emotion analysis model calculates a probability of each emotion class by applying a softmax function. Output data from the emotion analysis model is an array of floating-point numbers such as a negative emotion score of 0.92 and a stress index of 0.88. The analysis unit constructs a prompt character string by integrating these analysis results. The analysis unit inputs this prompt character string into the large language model to generate a final analysis result object. Thereby, the system mimics a complex cognitive process in which a human counselor reads and understands text, summarizes a main point, and infers an emotional state, on a computer at high speed and quantitatively. The system extracts an objective feature amount and a numerical value from subjective text data. The system constructs robust foundation data for a subsequent logical determination process.

Furthermore, the analysis unit searches for a case having a keyword matching or similar to “abusive language”, “ignoring”, “difficulty in going to work”, or “insomnia” by referring to an in-house past personnel case database using the similar case search model of the generative AI, and extracts a countermeasure such as “in a past case where abusive language from a boss and ignoring from colleagues occurred simultaneously, an interview with an industrial physician and an investigation by a human resources department were conducted, and a reassignment for a certain period and counseling by an external counselor were effective”. A specific example of a prompt sentence to be read by the generative AI includes “Search the database for a past case similar to the following consultation content and keywords, and summarize a countermeasure and a result. Consultation content: ‘I am mentally cornered due to abusive language from my boss and ignoring from my colleagues.’ Keywords: ‘abusive language’, ‘ignoring’, ‘mental burden’”. Specifically, in this specific example, the analysis unit inputs the extracted keyword list “abusive language”, “ignoring”, “difficulty in going to work”, and “insomnia” into a vectorization module. The vectorization module acquires a word embedding vector of each keyword. The vectorization module generates one query vector by average-pooling these vectors. The query vector is, for example, a 768-dimensional dense vector. The analysis unit inputs the query vector into the similar case search model. The similar case search model functions as a search engine of a vector database. Input data to the similar case search model is the generated query vector. The similar case search model calculates a cosine similarity between the query vector and tens of thousands of past case vectors pre-calculated and stored in the database. The similar case search model sorts the cases in descending order by the similarity score. Output data from the similar case search model is a list of pairs of top three case IDs having the highest similarity scores and the scores. The analysis unit acquires text data of the case from the relational database using the case ID. The analysis unit generates a prompt character string by combining the acquired case text data and the current consultation content text. The analysis unit inputs the prompt character string into the large language model. Input data to the large language model is, for example, a text token sequence “Consultation content: I am mentally cornered due to abusive language from my boss and ignoring from my colleagues. Past case: An interview with an industrial physician and a reassignment were implemented for abusive language and ignoring from a boss, resulting in improvement.” The large language model understands the input context and generates a summary of a countermeasure. Output data from the large language model is a text character string “In a past case where abusive language from a boss and ignoring from colleagues occurred simultaneously, an interview with an industrial physician and an investigation by a human resources department were conducted, and a reassignment for a certain period and counseling by an external counselor were effective”. Thereby, the system executes an advanced search based on semantic closeness in a high-dimensional vector space, rather than a simple exact match search of a keyword. The system discovers an appropriate case by absorbing an orthographical variant and a difference in expression. The system directly applies past organizational knowledge to current problem solving. The system automates a countermeasure planning process in a data-driven manner.

The support guidance unit automatically generates specific feedback and advice for the employee by the generative AI based on the determination result by the analysis unit and the countermeasure of the past case, such as “Since there is a high possibility of serious harassment and a mental disorder in the current situation, consultation with an industrial physician or a human resources department is recommended”, “In similar past cases, an interview with an industrial physician, workload adjustment, and counseling by an external counselor were effective”, and “First, prioritize physical condition management, and taking a leave of absence can also be considered as necessary”, and presents the specific feedback and advice on a screen of the terminal. A specific example of a prompt sentence to be read by the generative AI includes “Generate optimal feedback and advice for the employee based on the following consultation content, emotion score, and past case information. Consultation content: ‘Mentally cornered due to abusive language from the boss and ignoring from colleagues.’ Emotion score: 0.92. Past case: ‘An interview with an industrial physician, relocation, and counseling by an external counselor were effective.’”. Specifically, in this specific example, the support guidance unit loads an analysis result object and countermeasure text of a similar case onto a memory. The support guidance unit inserts these pieces of data into a predetermined prompt template. The support guidance unit inputs the constructed prompt character string into the generative AI. The generative AI is a large language model executed on a compute node dedicated to inference. Input data to the generative AI is a prompt character string including text “Consultation content: ‘Mentally cornered due to abusive language from the boss and ignoring from colleagues.’ Emotion score: 0.92. Past case: ‘An interview with an industrial physician, relocation, and counseling by an external counselor were effective.’”. The input data is converted into a tensor of numerical indices by a tokenizer. The generative AI processes the input tensor using a multi-layer transformer block. The generative AI calculates a contextual dependency and predicts an optimal token to be output next. Output data from the generative AI is a text character string constituting specific advice such as “Since there is a high possibility of serious harassment and a mental disorder in the current situation, consultation with an industrial physician or a human resources department is recommended”, “In similar past cases, an interview with an industrial physician, workload adjustment, and counseling by an external counselor were effective”, and “First, prioritize physical condition management, and taking a leave of absence can also be considered as necessary”. The support guidance unit receives this text character string. The support guidance unit formats the text character string into an HTML format. The support guidance unit transmits the formatted data to the terminal. The terminal renders the received data in a designated container area on the screen. Thereby, the system integrates a plurality of data sources, which are the input content of the employee, the objective emotion score, and the past successful case, to generate extremely persuasive personalized feedback. The system presents a specific and executable next action to the employee. The system reduces the anxiety of the employee and strongly supports voluntary access to an appropriate consultation desk.

When the employee desires an interview with the support destination, an appointment management unit searches a schedule of the support destination such as the industrial physician, the human resources department, or the external counselor, automatically proposes the earliest possible date and time for the interview, and confirms a reservation by checking against the convenience of the employee. For example, guidance such as “An interview with an industrial physician is possible at 10:00 am next Tuesday. Do you want to confirm the reservation?” is displayed, and when the reservation is confirmed, a reminder notification is also performed. Specifically, in this specific example, the terminal detects an event in which the employee clicks a button for desiring an interview on the screen. The terminal transmits a request including an interview desire flag to the server. The appointment management unit of the server receives the request. The appointment management unit specifies an ID of the industrial physician who is the recommended support destination. The appointment management unit transmits an HTTP GET request to an API endpoint of a schedule management system of the industrial physician. The appointment management unit acquires free time frame data of the industrial physician for the next one week as a JSON array. The appointment management unit issues a query to a schedule database of the employee. The appointment management unit acquires schedule data of the employee. The appointment management unit inputs both pieces of data into a comparison algorithm. Input data to the comparison algorithm is a binary vector indicating the free time of the industrial physician and a binary vector indicating the free time of the employee. The comparison algorithm executes a bitwise logical AND operation. Output data from the comparison algorithm is a binary vector indicating a time frame in which both are free. The appointment management unit extracts a time frame closest to the current time from the output data. The appointment management unit converts the extracted time frame into a text message “An interview with an industrial physician is possible at 10:00 am next Tuesday. Do you want to confirm the reservation?”. The appointment management unit transmits this message to the terminal. The terminal displays the message as a dialog box. The terminal detects an event in which the employee clicks a confirmation button, and transmits a confirmation request to the server. The appointment management unit receives the confirmation request. The appointment management unit inserts a reservation record into the corresponding time frame of the database. The appointment management unit registers a reminder job to be executed 24 hours before the reservation date and time in a message queue. The reminder job generates a push notification upon execution and transmits the push notification to the terminal. Thereby, the system completely automates a complicated process of adjusting the schedule of the interview. The system minimizes the time required for the adjustment and realizes a prompt start of support. The system improves an implementation rate of the interview by a reminder function.

A report generation unit automatically generates a detailed report including a summary of the consultation content, an extracted keyword, an emotion analysis result, a main point of the past case, recommended advice, appointment information, a follow-up proposal, and the like by the generative AI, and provides the detailed report to the support destination and an administrator. A specific example of a prompt sentence to be read by the generative AI includes “Create a detailed report for the support destination based on the following consultation content, emotion score, past case, and advice information.”. Specifically, in this specific example, the report generation unit extracts all data related to the consultation session from the database. The report generation unit integrates the extracted data to construct one JSON object. The report generation unit maps this JSON object to a prompt template. The report generation unit inputs the constructed prompt character string into the large language model. Input data to the large language model is a character string including an instruction sentence “Create a detailed report for the support destination based on the following consultation content, emotion score, past case, and advice information.” and a text representation of each piece of data following the instruction sentence. The input data is converted into a tensor of several thousand dimensions and input into the model. The large language model logically reconstructs the input information. The large language model generates report text in a formal style suitable for the support destination to read. Output data from the large language model is structured text data including a heading, a bullet point, and a paragraph. The output data includes sections such as “Consultation Overview”, “Emotion Analysis Result”, and “Recommended Countermeasure”, for example. The report generation unit receives this text data. The report generation unit inputs the text data into a PDF generation library. The PDF generation library renders the text data according to a designated layout, and generates a PDF file in a binary format. The report generation unit inputs the PDF file into an encryption algorithm. The encryption algorithm encrypts the file using a common key. The report generation unit stores the encrypted file in a secure storage. The report generation unit grants an access authority to the file to a specific account of the industrial physician or the human resources department. The report generation unit generates a notification message including a URL for access, and transmits the notification message to a system of the support destination. Thereby, the system automatically provides a material for comprehensively and objectively grasping the situation of the consulter before the support destination conducts the interview. The system saves the support destination the trouble of conducting a hearing from scratch. The system makes it possible to concentrate the time of the interview on a discussion of a more constructive solution. The system dramatically improves the quality and efficiency of support work.

A privacy protection unit converts the consulter ID into a random token, and performs processing so that information capable of identifying an individual is not included in the consultation content or the report. A database management unit centrally manages the consultation content, the session log, the past personnel case, support destination information, an appointment history, report data, and the like, and thoroughly implements an access authority and encryption processing. Specifically, the privacy protection unit executes a one-way conversion algorithm using a hash function. The privacy protection unit converts input character string data of the consulter ID into a fixed-length hash value vector. The privacy protection unit adds a salt value and executes hashing. Thereby, the system invalidates a rainbow table attack. The privacy protection unit detects a personal information entity in the text data using the natural language processing model. The privacy protection unit executes a named entity extraction algorithm. The privacy protection unit replaces a character string such as a name or a department name with a masking character string. The database management unit executes a relational database management system. The database management unit stores each piece of data as a normalized table group. The database management unit encrypts stored data using an advanced encryption standard algorithm. The database management unit uses a 256-bit encryption key. The database management unit executes a role-based access control mechanism. The database management unit determines whether access is possible on a record-by-record basis according to an authority level of a user. Thereby, the system reduces an information leakage risk. The system improves a query execution speed of data search. The system speeds up index reference for large-scale log data. The system functions as a secure data management infrastructure that handles medical information and personnel information.

A trend analysis unit automatically analyzes a company-wide harassment occurrence trend, a mental disorder occurrence rate for each department, a chronological change in the consultation content, an effectiveness evaluation of a recurrence prevention measure, and the like, and provides them to a management layer and the human resources department as a dashboard or a report. A multilingual support unit realizes consultation reception, analysis, feedback, and report generation in multiple languages for foreign employees, and the generative AI performs automatic translation and multilingual emotion analysis. For example, by using an English prompt such as “Please describe your workplace issue in detail. The system will analyze your input and provide advice.” or a Chinese prompt such as “ [symbol] [symbol] [symbol] , [symbol] [symbol] [symbol] ”, it is possible to cope with diverse language environments. Specifically, the trend analysis unit executes a time-series data analysis algorithm. The trend analysis unit acquires a feature amount vector group extracted from a past consultation log as input data. The input data is a multidimensional numerical tensor including the number of monthly consultations of each department and an average value of the emotion score. The trend analysis unit executes an autoregressive integrated moving average model. The trend analysis unit predicts a future mental disorder occurrence rate. The trend analysis unit outputs a prediction result as probability distribution data. The output data is an array of floating-point numbers indicating a risk score of each department for the next month. The trend analysis unit inputs the output result into threshold determination processing. The trend analysis unit specifies a department whose risk score exceeds a specified value. The trend analysis unit transmits information of the specified department to a dashboard drawing module. The multilingual support unit executes a machine translation neural network based on a transformer architecture. The multilingual support unit converts an input foreign language text character string into a word embedding vector. The multilingual support unit generates a context vector of an input language using an encoder layer. The multilingual support unit generates a token sequence of a target language using a decoder layer. The multilingual support unit executes a multilingual emotion analysis model. The multilingual emotion analysis model is a large language model pre-trained in multiple languages. The multilingual emotion analysis model outputs an emotion polarity score from the input text. Thereby, the system achieves homogeneous analysis accuracy across language barriers. The system improves calculation efficiency of personnel management in a global enterprise. The system is applied to mental health support of an organization having multinational employees.

As described above, the employee support system of the present invention realizes everything from consultation reception to analysis, feedback, support destination guidance, appointment setting, report generation, privacy protection, trend analysis, and multilingual support in an integrated manner, and greatly contributes to improving the mental health of employees and improving the ease of working of the entire company with the generative AI as a core. Specifically, the system executes a microservice architecture that integrates a plurality of independent processing modules. The system executes data communication between the respective modules via an asynchronous messaging queue. The system arranges the generative AI model in a compute node dedicated to inference. The system executes an auto-scaling function of dynamically increasing or decreasing the number of compute nodes according to a traffic volume of input data. The system parallelizes a natural language processing task. The system applies a tensor parallelization method in inference processing of the large language model. The system divides and arranges weight parameters of the model in a plurality of GPU memories. The system performs distributed processing of a matrix multiplication operation. Thereby, the system enables execution of a large-scale model exceeding a limitation of a single hardware resource. The system significantly shortens inference latency. The system completely replaces a process of information collection and initial evaluation manually performed by a human counselor with automatic processing on a computer. The system establishes an objective data-driven evaluation standard excluding a human subjective bias. The system quantifies a complex linguistic nuance through a vector operation in a high-dimensional space. The system functions as a health management platform used by the human resources department and the industrial physician of the company. The system supports specific measure planning for improving employee engagement and reducing a turnover rate.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The nursing care site support system of the present invention is composed of a server and a terminal, and has a consultation receiving unit, an analysis unit, a support guidance unit, a database management unit, a privacy protection unit, a user interface unit, a report generation unit, an appointment management unit, a multilingual support unit, and a trend analysis unit. The terminal is an information terminal such as a personal computer, a smartphone, a tablet, a wearable device, or a voice input dedicated terminal used by a nursing care staff member, and the server is a high-performance computing resource installed in a cloud environment or on an in-facility network. The terminal and the server communicate via a network such as the Internet or an intranet. Specifically, the system executes a client-server type distributed computing architecture. The server includes a cluster system in which a plurality of compute nodes are bundled. The server is equipped with a dedicated hardware accelerator for speeding up learning and inference of a large-scale neural network. The terminal executes an event-driven program that detects an input event from a user. The terminal packetizes input data and transmits the packetized input data via a communication protocol stack. The server includes a load balancer. The load balancer receives simultaneous connection requests from a plurality of terminals. The load balancer equally distributes the requests to the respective compute nodes using a round-robin algorithm. The server executes an in-memory database. The server caches frequently accessed session data on a main memory. Thereby, the system eliminates a bottleneck of disk IO. The system maintains a response speed in milliseconds even for simultaneous access from nursing care staff members on a scale of several thousands. The system executes a data compression algorithm that optimizes consumption of a network bandwidth. The system guarantees stable operation even in an environment where a communication infrastructure is fragile, such as a nursing care facility. The system streamlines streaming processing of voice data and image data requiring real-time performance. The system is applied as a work support infrastructure for a large-scale nursing care provider or a corporation that supervises a plurality of facilities.

First, a user interface of the consultation receiving unit is realized on the terminal side, and the nursing care staff member can access the system using a dedicated application, a web browser, a chatbot, a voice input interface, or the like, and input consultation content in a free description format. For example, it is possible to comprehensively input all worries, stress, and troubles that can occur at the site, such as worries about abusive language and violence from a user, ignoring and backbiting from colleagues, exhaustion due to night shifts and excessive shifts, unreasonable complaints from a user's family, poor physical condition due to an increase in the amount of work, a sense of isolation in the workplace, difficulty in responding to nursing care refusal, a new employee guidance burden, difficulty in taking a vacation, a mental limit, insomnia, palpitation, unstoppable tears, difficulty in going to work, bullying in the workplace, power harassment, sexual harassment, moral harassment, burnout, communication failure with a user, deterioration of human relations in a team, trouble with an outsourcing contractor, overwork during an infectious disease epidemic, an emergency response burden during a disaster, and business confusion due to introduction of ICT equipment. In the case of voice input, it is also possible to perform voice recognition processing on the terminal side, convert the voice input into text data, and transmit the text data to the server. An image attachment function and a file attachment function are also provided, and for example, “an image of a letter received from a user”, “a memo describing complaint content”,

“an excerpt from a business log”, and the like can also be transmitted. The input consultation content is transmitted from the terminal to the server by encrypted communication, and is recorded as a session log together with information such as a staff ID (or an anonymous token), an input date and time, consultation content text, a terminal type, an IP address, position information (when permitted), a consultation category (when optional), and attached file information in the consultation receiving unit on the server side. For example, it is designed so that even when the nursing care staff member consults a plurality of times, a past consultation history can be managed in chronological order. Specifically, the terminal executes a multimodal input processing module. The terminal converts an analog voice signal acquired from a microphone into digital voice waveform data by sampling processing. The terminal executes a fast Fourier transform algorithm. The terminal converts the voice waveform data into two-dimensional array data of a frequency spectrogram. The terminal executes a voice recognition neural network including an acoustic model and a language model. The terminal infers a text character string from the spectrogram. The terminal stores image data acquired from a camera in a memory as an RGB three-dimensional pixel tensor. The terminal executes resize processing and normalization processing on the image data. The terminal generates a data payload in a multipart format in which the input text data, the text data derived from voice, and the image data are integrated. The terminal encrypts the data payload using a transport layer security protocol. The terminal safely exchanges a common key using a public key cryptography. The terminal encrypts a payload body using a common key cryptography. The server decrypts the received encrypted packet. The server converts the decrypted data into a structured JSON format object. The server writes the JSON object into a time-series database. The server constructs an index using the staff ID as a primary key and the input date and time as a sort key. Thereby, the system handles diverse input formats as a unified data structure. The system prevents data interception via a network and ensures confidentiality. The system provides an interface that can be intuitively operated by a staff member at a nursing care site.

Next, the analysis unit on the server side utilizes the generative AI to analyze the consultation content from multiple angles. The generative AI used here integrates a plurality of natural language processing and multimodal technologies such as a large language model, an emotion analysis model, a summary generation model, a similar case search model, and an image analysis model. First, the consultation content text is input into the natural language processing model of the generative AI, and a characteristic keyword (for example, “abusive language”, “violence”, “ignoring”, “overwork”, “user trouble”, “isolation”, “exhaustion”, “mental burden”, “burnout”, “complaint”, “nursing care refusal”, “shift problem”, “guidance burden”, “poor physical condition”, “insomnia”, “palpitation”, “unstoppable tears”, “difficulty in going to work”, “bullying”, “power harassment”, “sexual harassment”, “moral harassment”, “communication failure”, “deterioration of human relations”, “trouble with an outsourcing contractor”, “infectious disease”, “disaster response”, “ICT confusion”, or the like) is extracted from the consultation sentence. Since the keyword extraction is performed in consideration of not only a word level but also a context and a nuance of an expression, expressions such as “Recently, I am afraid to go to the workplace”, “No one talks to me”, “I am yelled at every day”, “My body cannot hold up due to continuous night shifts”, “Unreasonable demands from the family are painful”, and “I feel stressed because I do not understand how to operate a new system” are also appropriately recognized, for example. Specifically, the analysis unit executes a large language model based on a transformer architecture. The analysis unit divides the input consultation content text into a token sequence in units of subwords. The analysis unit converts each token into a multidimensional word embedding vector. The analysis unit executes a self-attention mechanism. The analysis unit calculates a dependency between respective words in a context, and generates a feature amount vector reflecting the context. The analysis unit inputs the feature amount vector into a classification head for keyword extraction. Input data is a 512-dimensional vector sequence converted from text “My body cannot hold up due to continuous night shifts”, for example. The analysis unit outputs a probability that each token belongs to a specific keyword class. Output data is an array of floating-point numbers including a probability value from 0 to 1 for each keyword class. For example, a probability of an “overwork” class is output as 0.95, and a probability of a “poor physical condition” class is output as 0.88. The analysis unit specifies a class whose probability value exceeds a predetermined threshold as an extracted keyword. The analysis unit transmits a list of the extracted keywords to a subsequent similar case search module. Unlike rule-based dictionary matching, the analysis unit calculates a latent meaning as a distance in a vector space even from an unknown expression or a figurative expression. Thereby, the system absorbs orthographical variants and ambiguous expressions, and realizes highly accurate keyword extraction. The system replaces a human reading comprehension process with an advanced matrix operation. The system visualizes a latent issue of the nursing care staff member without omission.

Furthermore, the generative AI automatically generates a summary of the entire consultation content. For example, it outputs a summary sentence that allows a third party to grasp the situation of the consulter at a glance, such as “Mental burden increases due to continuous abusive language and ignoring from a user, resulting in a state of insomnia and difficulty in going to work”, “Backbiting and harassment from colleagues continue, and a sense of isolation is strengthening”, “Poor physical condition due to night shifts and an increase in the amount of work, and exhausted without being able to take a day off”, “Business burden rapidly increases due to disaster response, and feeling a limit both mentally and physically”, or “Business is confused due to introduction of new ICT equipment, and stress is increasing”. The summary generation is designed so that a subjective emotion of the consulter and a severity of the situation are also reflected. Specifically, the analysis unit executes a summary generation neural network having an encoder-decoder structure. The summary generation model inputs a token sequence of the input long consultation text into an encoder. Input data is an integer array of up to 2048 tokens. The encoder compresses the entire input sequence into a fixed-length latent representation vector using a multi-layer transformer block. The decoder predicts tokens of the summary sentence one by one using the latent representation vector and an autoregressive generation process. The decoder executes a beam search algorithm. The decoder selects a token sequence having the highest product of probabilities from among a plurality of generation candidates. The summary generation model generates a character string of summary text as output data. Output data is a short text character string such as “Exhaustion and insomnia due to an increase in night shifts”, for example. The summary generation model updates a weight parameter so as to minimize an error from a correct summary using a cross-entropy loss function during learning. The summary generation model allocates a high weight to a word indicating an emotional expression or a severity in an input sentence by analyzing an attention weight. The analysis unit transmits the generated summary text to a report generation module and the database management unit. Thereby, the system converts long unstructured text into structured summary information in a short time. The system significantly reduces a cognitive load for an administrator to quickly grasp a large amount of consultation content. The system dramatically improves efficiency of information transmission.

In addition, the emotion analysis model of the generative AI analyzes an emotion included in the consultation content, and digitizes a plurality of emotion parameters such as a negative emotion score, a stress index, an anxiety level, a depressive tendency, anger, sadness, fear, a sense of helplessness, a sense of frustration, a sense of despair, an anger explosion risk, and an intention to leave a job. For example, when many expressions such as “painful”, “suffering”, “at my limit”, “cannot sleep”, “want to die”, “impossible anymore”, “no one helps me”, “want to quit”, “cannot suppress anger”, and “tears do not stop” are included, the negative emotion score becomes 0.9 or more, and it is determined as a sign of a serious mental disorder or a turnover risk. Since the emotion analysis is performed in consideration of not only the frequency of words and phrases but also the context and the past consultation history of the consulter, trends such as “expressions are heavier than before”, “consultation frequency is increasing”, “consultation of the same content is repeated”, and “a new keyword is added” can be automatically detected, for example. Specifically, the analysis unit executes an emotion analysis neural network fine-tuned specifically for a multidimensional emotion classification task. The emotion analysis model receives, as input data, a tensor in which an embedding vector of the current consultation text and a time-series feature amount vector extracted from the past consultation history are combined. The input data is, for example, a vector array having 768 dimensions. The emotion analysis model calculates an intensity of each emotion category using a fully connected layer and a softmax function. The emotion analysis model outputs scores of the plurality of emotion parameters as output data. The output data is dictionary format data of floating-point numbers in a range of 0 to 1, such as a negative emotion score of 0.92, a turnover intention score of 0.85, and an anger explosion risk of 0.40, for example. The analysis unit inputs the output score group to a threshold determination module. The analysis unit sets an emergency response flag to true when the negative emotion score exceeds 0.8 which is a preset threshold. When the emergency response flag is true, the analysis unit triggers a process of immediately transmitting an alert notification to an administrator terminal. The system models a time-series change in the past consultation history using a recurrent neural network or a long short-term memory network. The system calculates an emotion deterioration trend over time as a gradient. Thereby, the system quantitatively visualizes a minute emotion change or accumulated stress that a human counselor tends to overlook. The system converts a subjective emotion evaluation into an objective numerical index, and realizes data-driven risk management.

The analysis unit further refers to a past nursing care case database accumulated in a facility. In this database, past consultation cases, countermeasures, results, involved support destinations (a psychologist, a care manager, a consultation desk, an external counselor, an industrial physician, an administrator, an external expert, and the like), recurrence prevention measures, a period from consultation to resolution, a recurrence rate, staff satisfaction, presence or absence of follow-up, presence or absence of a business improvement proposal, effectiveness of a turnover prevention measure, and the like are recorded. The generative AI collates the keyword and the summary of the consultation content with the content of the past cases, and automatically extracts a similar case and its countermeasure, such as “in a past case where abusive language and ignoring from a user occurred simultaneously, consultation with a psychologist, work shift adjustment by a care manager, and use of external counseling were effective”, “in a case of exhaustion due to a night shift burden or an excessive amount of work, shift adjustment, review of work sharing, and a regular follow-up interview were implemented, leading to recurrence prevention”, “in a case of backbiting from colleagues or a sense of isolation, a team building measure or group counseling by an external counselor was effective”, “in a case of confusion due to introduction of ICT equipment, training by an expert, manual preparation, and introduction of a peer support system were effective”, and “in a case of an emergency response burden during a disaster, an increase in temporary staff, reconstruction of work sharing, and enhancement of psychological care were effective”, for example. When a plurality of similar cases exist, optimal feedback is generated by also taking into consideration the effect of the countermeasure, the recurrence rate, the staff satisfaction, the turnover prevention effect, the business improvement effect, and the like. Specifically, the analysis unit executes a similarity search algorithm using a vector database. The analysis unit inputs the summary text of the current consultation content into a sentence embedding model. The analysis unit converts the input text into a 768-dimensional high-dimensional dense vector. The analysis unit transmits this dense vector as a query vector to the vector database. The vector database stores all past case texts by vectorizing them in advance. The vector database calculates a cosine similarity between the query vector and each stored case vector. The vector database outputs top K case records having a high cosine similarity. The output data is a structured list including metadata such as a case ID, a similarity score, countermeasure text, and a resolution rate. For example, a case A having a similarity score of 0.88 and a case B having a score of 0.85 are output. The analysis unit inputs the extracted case group to a ranking algorithm. The ranking algorithm calculates a comprehensive evaluation score by weighting and adding a reciprocal of the past recurrence rate and the staff satisfaction score in addition to the similarity score. The analysis unit selects the countermeasure of the case having the highest comprehensive evaluation score as an optimal solution. The analysis unit transmits the selected countermeasure data to the subsequent support guidance unit. Thereby, the system realizes an advanced information search based on semantic similarity, which is impossible with a simple keyword matching search. The system instantaneously computes and processes a vast amount of past knowledge to derive an optimal solution. The system provides a standardized problem-solving process that does not depend on personal experience.

The support guidance unit presents optimal feedback and advice to the nursing care staff member on the terminal based on the determination result by the analysis unit and the countermeasure of the past case. For example, the generative AI automatically generates specific and situation-dependent advice, such as “since there is a high possibility that the current situation is a serious mental burden, consultation with a psychologist or a care manager is recommended”, “in a past similar case, work shift adjustment and use of external counseling were effective”, “first, prioritize physical condition management, and taking a leave of absence can also be considered as necessary”, “there is a case that improved by receiving counseling by an external counselor”, “there is a case where review of work sharing and a team building measure led to recurrence prevention”, “when there is anxiety about ICT equipment operation, it is recommended to utilize training by an expert or peer support”, and “when a work burden during a disaster is large, it is effective to propose an increase in temporary staff and enhancement of psychological care to an administrator”, and displays the advice on a screen of the terminal. The feedback is designed to use empathetic and positive expressions in order to reduce the mental burden on the consulter. Specifically, the support guidance unit executes a text generation model using a prompt engineering technique. The support guidance unit constructs a system prompt by integrating the emotion score, the extracted keyword, and the countermeasure data of the optimal case received from the analysis unit. The input data is a structured text prompt such as “emotion score: 0.9, keyword: overwork, recommended countermeasure: shift adjustment”, for example. The text generation model generates feedback text in natural language based on the input prompt. The text generation model outputs a character string such as “It is a difficult situation. In past cases, shift adjustment was effective. Why don't you consult with your administrator?” as output data. The support guidance unit inputs the generated text to an emotion polarity filter. The emotion polarity filter determines whether the text does not include a negative expression. The support guidance unit formats the text that has passed the determination into display data in an HTML or JSON format. The support guidance unit transmits the display data to the terminal via a network. The terminal renders the received data as a chat window or a pop-up dialog on the screen using a rendering engine. Thereby, the system converts a mechanical data output into a natural language interface that is easy for a human to accept. The system lowers a psychological barrier of the user and promotes a transition to the proposed support measure. The system functions as an interactive agent and improves user experience.

Furthermore, when the nursing care staff member desires or when the system determines it necessary, the support guidance unit automatically specifies a support destination such as a psychologist, a care manager, a consultation desk, an external counselor, an industrial physician, an administrator, or an external expert, and automatically sets an appointment on the server side. For example, it searches for an available schedule of the psychologist, automatically proposes the earliest possible date and time for an interview, and confirms a reservation by collating with the convenience of the staff member. After the reservation is confirmed, the generative AI automatically generates a detailed report including a summary of the consultation content, an extracted keyword, an emotion analysis result, a main point of the past case, recommended advice, appointment information, a follow-up proposal, a business improvement proposal, and the like, and provides the report to the support destination in advance. The report includes an anonymous token of the consulter, a summary of the consultation content, an emotion score, a comparison with past cases, a recommended countermeasure, a proposal for follow-up, a turnover risk evaluation, a business improvement proposal, and the like. For example, information enabling the support destination to respond quickly and accurately is comprehensively described, such as “the consulter has consulted three times in the past two weeks, and the negative emotion score is on an upward trend”, “since a psychologist interview and work shift adjustment were effective in a past similar case, a similar response is recommended”, “since anxiety regarding ICT equipment operation is strong, additional training by an expert is proposed”, and “when a work burden during a disaster is large, an increase in temporary staff is considered”. Specifically, the appointment management unit executes a scheduling algorithm linked with an external calendar API. The appointment management unit transmits a query to a schedule database of the specified support destination, and acquires an array of available time slots. The appointment management unit calculates a logical product of work shift data of the staff member and the time slot array, and extracts an overlapping free time. The appointment management unit transmits the extracted date and time as a candidate list to the terminal. Upon receiving a selection event from the terminal, the appointment management unit inserts a reservation record on the database. The report generation unit executes a document generation neural network. The report generation unit receives various data points output from the analysis unit as input. The input data is a JSON object including summary text, a numerical array of emotion scores, and a list of extracted keywords. The report generation unit maps these data to each field of a predefined report template. The report generation unit generates explanatory text for each section using a natural language generation model. The report generation unit generates a report file in a PDF format or an HTML format as output data. The report generation unit transmits the generated report file to a terminal of the support destination via a secure communication channel. Thereby, the system completely eliminates an administrative communication overhead required for interview adjustment. The system provides highly analyzed context information to the support destination in advance, and dramatically improves the quality and efficiency of the interview.

In addition, in order to thoroughly ensure privacy protection of the nursing care staff member in all processes, a function of anonymizing personal information on the server side is provided. For example, the consulter ID is converted into a random token, and information capable of identifying an individual is not included in the consultation content or the report. Access logs and databases are also encrypted, and it is designed so that personal information cannot be accessed even with administrator privileges. Furthermore, the system is also capable of multilingual support, and even when a foreign staff member consults in his/her native language, automatic translation and multilingual emotion analysis are performed, and similar support can be received. For example, by using an English prompt such as “Please describe your workplace issue in detail. The system will analyze your input and provide advice.” or a Chinese prompt such as “ [symbol] [symbol] [symbol] , [symbol] [symbol] [symbol] ”, it is possible to cope with diverse language environments. Specifically, the privacy protection unit executes a cryptographic pseudorandom number generator. The privacy protection unit receives the consulter ID as input, and outputs a 256-bit UUID format anonymous token. The privacy protection unit stores a mapping table of the original ID and the token in an independent secure enclave area. The privacy protection unit applies a named entity recognition model to the text data, detects entities such as a person's name and a place name, and replaces them with a masking character such as an asterisk. The multilingual support unit executes a language determination algorithm. The multilingual support unit specifies a used language from a character code distribution or an N-gram feature amount of the input text. The multilingual support unit loads a machine translation model corresponding to the specified language onto a memory. The machine translation model encodes a token sequence of the input foreign language text into a common latent space vector. The machine translation model decodes a token sequence of Japanese, which is a standard language inside the system, from the latent space vector. The multilingual support unit generates translated Japanese text as output data. The multilingual support unit inputs this Japanese text to the subsequent analysis unit. The feedback text of the analysis result is translated into the original language through a reverse process and transmitted to the terminal. Thereby, the system establishes a secure data processing infrastructure compliant with personal information protection legislation. The system minimizes branching of processing logic due to language differences, and realizes computational efficiency of processing diverse language inputs with a single analysis pipeline.

Furthermore, for example, it is also possible to cope with a case where the nursing care staff member consults by voice input or in a chatbot format, and the generative AI can analyze the consultation content in real time using voice recognition or interactive natural language processing technology, and immediately return feedback. For example, even in a time zone when a person in charge is absent, such as at night or on a holiday, the generative AI automatically responds, thereby realizing an environment in which the nursing care staff member can consult with peace of mind at any time. In addition, by utilizing an image attachment or file attachment function, for example, “an image of a letter received from a user”, “a memo describing complaint content”, “an excerpt from a business log”, and the like are set as analysis targets, and an image analysis model performs handwritten character recognition and content summarization, and integrates them with text data to execute a comprehensive analysis. Specifically, the system executes a streaming voice recognition API. The system buffers voice packets continuously transmitted from the terminal. The system sequentially infers a text character string from a voice feature amount vector using a hidden Markov model or an end-to-end voice recognition neural network. The system executes a dialogue management module. The dialogue management module classifies a user's utterance intention, and maintains a context of a dialogue using a state transition machine. The image analysis unit executes an optical character recognition model based on a convolutional neural network. The image analysis unit executes preprocessing of edge detection and binarization on the input image tensor. The input data is, for example, a grayscale image tensor having a resolution of 1024×1024. The optical character recognition model detects a character region in the image as a bounding box, and infers a sequence of character codes from an image feature amount of each region. The image analysis unit generates an extracted text character string as output data. The output data is, for example, a character string such as “complaint content: response is slow” read from a handwritten memo. The system combines the extracted text with input text from voice or a keyboard, and inputs it to the analysis unit as an integrated text corpus. Thereby, the system integrally processes multimodal input data with a single natural language processing pipeline. The system provides an autonomous consultation desk operating 24 hours a day, eliminating temporal and spatial constraints. The system extracts semantic information from an image which is unstructured data, and improves the accuracy and comprehensiveness of the analysis.

In addition, trend analysis and statistical processing of the consultation content are also possible, and the generative AI can automatically analyze a facility-wide harassment occurrence trend, a mental disorder occurrence rate for each department, a time-series change in the consultation content, an effectiveness evaluation of a recurrence prevention measure, a prediction of a turnover risk, extraction of a business improvement proposal, and the like, and provide them as a dashboard or a report to a management layer or an administrative department. For example, it is possible to provide information useful for grasping issues of the entire organization and planning measures, such as “this month, mental burden consultation from night shift staff is on an increasing trend”, “the most frequent consultation content in the past half year was ‘overwork’”, “the effect of the team building measure implemented as a recurrence prevention measure was high”, “stress consultation after the introduction of ICT equipment is increasing”, and “the turnover risk is increasing along with an increase in the work burden during a disaster”. Specifically, the trend analysis unit executes a distributed processing framework for a large-scale dataset. The trend analysis unit extracts all session log data for a certain past period from a database management unit. The trend analysis unit applies a MapReduce algorithm to the extracted data, and executes aggregation operations by department, by time zone, and by keyword in parallel. The trend analysis unit executes predictive modeling based on machine learning. The trend analysis unit constructs a turnover risk prediction model using a random forest or gradient boosting decision tree algorithm. The prediction model receives, as input data, a moving average of past emotion scores of each staff member, a consultation frequency, and a one-hot encoding vector of an extracted keyword. The input data is, for example, a feature amount vector having 100 dimensions. The prediction model outputs a turnover probability of each staff member within three months as output data. The output data is a continuous value in a range of 0 to 1. The trend analysis unit aggregates this turnover probability for each department, and generates two-dimensional array data of a risk heat map. The trend analysis unit transmits the generated data to a data visualization module. This module converts the data into vector graphics data of a bar chart or a line chart, and renders it on a web browser. Thereby, the system quantitatively visualizes an organizational issue from a macro perspective, not limited to individual consultation responses. The system supports decision-making of the management layer in a data-driven manner, and enables planning of a preventive personnel measure. The system computationally discovers a correlation that is difficult for a human to recognize from a vast amount of log data.

As described above, in the embodiment of the present invention, the user interface portion of the consultation receiving unit is realized on the terminal side, and main processes such as reception and recording of the consultation content, analysis by the generative AI, support destination guidance, appointment setting, report generation, a privacy protection function, a trend analysis function, a multilingual support function, and an image/file analysis function are realized on the server side. The generative AI plays an indispensable role in overall core processing of the system, such as analysis of the consultation content, summary generation, emotion analysis, collation with past cases, advice generation, automatic report creation, trend analysis, statistical processing, multilingual support, and image analysis. For example, when the nursing care staff member inputs “recently, abusive language from users has increased, and I feel depressed every day”, the generative AI extracts “abusive language” and “feeling depressed”, refers to a past case of “mental disorder due to abusive language”, and automatically generates advice such as “a psychologist interview and work shift adjustment were effective”. Furthermore, for example, when “ignoring from colleagues continues, and I am isolated in the workplace” is input, the generative AI extracts “ignoring” and “isolation”, refers to a past case of “mental disorder due to isolation”, and generates feedback such as “consultation with a consultation desk and a team building measure were effective”. Furthermore, for example, when “I do not understand the operation of new ICT equipment and feel stress” is input, the generative AI extracts “ICT confusion” and “stress”, refers to a past case of “stress at the time of ICT introduction”, and generates advice such as “additional training by an expert and peer support were effective”. Furthermore, for example, when “the work burden has rapidly increased due to disaster response, and I feel at my limit both mentally and physically” is input, the generative AI extracts “disaster response”, “overwork”, and “mental burden”, refers to a past case of “increase in work burden during a disaster”, and generates feedback such as “an increase in temporary staff and enhancement of psychological care were effective”. Specifically, the system executes a hybrid processing architecture combining edge computing and cloud computing. The terminal is in charge of a low-load operation such as lightweight input validation and initial processing of a voice waveform. The server centrally executes a high-load tensor operation using a GPU cluster and a search process of a large-scale database. The generative AI is managed by a pipeline control module that orchestrates a plurality of specialized neural network models. The pipeline control module inputs the input text to a keyword extraction model, an emotion analysis model, and a summary generation model in parallel. The pipeline control module synchronously collects output tensors from the respective models, and generates an integrated context vector. The pipeline control module uses this context vector as a query for a similar case search model. The pipeline control module inputs a search result and the context vector to a text generation model, and outputs a final advice character string. For example, when the input data is a character string “abusive language increases and I feel depressed”, the system tokenizes this, processes it with each model, and then outputs a character string “a psychologist interview is recommended” and a control flag for activating an appointment setting module as output data. The system detects this control flag and automatically starts a subsequent reservation process. Thereby, the system executes a complex multi-stage inference process without delay. The system maximizes the processing throughput of the entire system while maintaining loose coupling of each processing module. The system completes advanced logical inference and decision-making without human intervention.

As described above, the embodiment of the present invention uses advanced natural language processing and emotion analysis technology, image analysis technology, trend analysis technology, and multilingual support technology with the generative AI as a core to analyze the consultation content of the nursing care staff member from multiple angles and quickly, automatically presents an optimal support measure utilizing the past case database, and realizes cooperation with a support destination, automatic report generation, trend analysis, multilingual support, and image/file analysis consistently as necessary, and is a system that greatly contributes to improvement of mental health of staff at a nursing care site, improvement of ease of working at the site, turnover prevention, business improvement, and soundness of the entire organization. Specifically, the system executes a workflow engine that automates all data flows from acquisition of input data to execution of a final support action. The system persists an operation result in each processing step as a state transition log. The system executes an online learning loop for continuously improving the inference accuracy of the machine learning model. The system collects feedback from the user and an actual resolution result at the support destination as a correct answer label. The system periodically re-learns a weight parameter of each neural network model using this correct answer label. The system calculates a gradient of a loss function using an error backpropagation method, and updates the parameter by an optimization algorithm. The system calculates a reliability score for an inference result of the model, and includes a fallback mechanism that requests a review process by a human administrator when the reliability is low. Thereby, the system adapts to issues and trends peculiar to the facility as the operation period becomes longer, and the analysis accuracy improves in a self-organizing manner. The system functions not merely as a static rule-based system but as an adaptive computing system that evolves in a data-driven manner. The system provides a scalable solution by a computer science approach to social issues of chronic human resource shortage and overwork in the nursing care industry. The system simultaneously achieves optimization of a labor environment and maximization of human capital.

### System Configuration

The system according to the present embodiment comprises a consultation receiving unit, an analysis unit, a support guidance unit, a database management unit, a privacy protection unit, a user interface unit, a report generation unit, an appointment management unit, a multilingual support unit, a trend analysis unit, and an image analysis unit. The consultation receiving unit has a function of, when a nursing care staff member accesses from various terminals such as a personal computer, a smartphone, a tablet, a wearable device, and a dedicated voice input terminal, receiving consultation content by various methods such as text input, voice input, image attachment, and file attachment, and recording the consultation content as a session log together with accompanying information such as an input date and time, a staff ID or an anonymous token, a terminal type, an IP address, position information, a consultation category, and attached file information. For example, it is possible to comprehensively receive all kinds of worries, stress, and trouble that can occur at a site, such as the nursing care staff member saying “It is painful to receive abusive language from a user”, “I am ignored by my colleagues and isolated”, “I am about to get sick due to continuous night shifts”, “I attach an excerpt of a work log”, or “I send an image of a letter received from a user”. In the case of voice input, voice recognition processing is performed on the terminal side, and the voice input is converted into text data and transmitted to the server. In the case of image attachment, the content of image data is also set as an analysis target in cooperation with the image analysis unit. Specifically, the system executes each unit as a group of containerized applications based on a microservices architecture. The consultation receiving unit provides an endpoint of a RESTful application programming interface. The consultation receiving unit extracts the terminal type and the IP address from header information of an HTTP request. The consultation receiving unit extracts text data and binary data from a payload. The consultation receiving unit saves an image file transmitted in a multipart form data format in a temporary storage, and records a file path thereof as metadata. The consultation receiving unit serializes the received data into a session log object in a JSON format. The consultation receiving unit publishes this object to a queue of a message broker. The image analysis unit subscribes to a message from the queue, acquires the image path, and loads the image data into a memory. The image analysis unit extracts a feature amount map from the image using a convolutional neural network. The image analysis unit detects a text region from the feature amount map, and converts the text region into character string data by an optical character recognition algorithm. Thereby, the system processes various input modalities asynchronously and scalably. The system constructs a flexible data collection infrastructure that does not depend on a specific input format. The system separates front-end input processing and back-end heavy analysis processing, and improves responsiveness of the entire system.

The analysis unit has a function of analyzing the received consultation content from multiple angles using generative AI, extracts a keyword such as “abusive language”, “violence”, “ignoring”, “overwork”, “user trouble”, “isolation”, “exhaustion”, “mental burden”, “burnout”, “complaint”, “care refusal”, “shift problem”, “guidance burden”, “poor physical condition”, “insomnia”, “palpitation”, “uncontrollable tears”, “difficulty in going to work”, “bullying”, “power harassment”, “sexual harassment”, “moral harassment”, “communication failure”, “deterioration of human relations”, “outsourcing trouble”, “infectious disease”, “disaster response”, or “ICT confusion” by a natural language processing model, automatically generates a summary of the entire consultation content by a summary generation model, and digitizes a plurality of emotion parameters such as a negative emotion score, a stress index, an anxiety level, a depressive tendency, anger, sadness, fear, a sense of helplessness, a sense of frustration, a sense of despair, an anger explosion risk, and a turnover intention by an emotion analysis model. For example, when many expressions such as “painful”, “suffering”, “at my limit”, “cannot sleep”, “want to die”, “impossible anymore”, “no one helps me”, “want to quit”, “cannot suppress anger”, and “uncontrollable tears” are included, it is determined as a sign of a serious mental disorder or a turnover risk. Furthermore, a similar case search model searches for a case having a keyword matching or similar to the consultation content by referring to a past nursing care case database accumulated in a facility, and extracts a countermeasure such as “in a past case where abusive language and ignoring from a user occurred simultaneously, consultation with a psychologist, work shift adjustment by a care manager, and use of external counseling were effective” or “in a case of exhaustion due to a night shift burden or an excessive amount of work, shift adjustment, review of work sharing, and a regular follow-up interview were implemented, which led to prevention of recurrence”. A specific example of a prompt sentence to be read by the generative AI includes “Analyze the following consultation content, extract a main keyword, generate a summary sentence, calculate an emotion score, and present a countermeasure if there is a similar past case. Consultation content: ‘I am about to get sick due to continuous night shifts, but I cannot consult anyone.’”. Specifically, the analysis unit executes a multi-task learning model that executes a plurality of inference tasks in a single forward pass. The analysis unit tokenizes the input consultation text, and inputs the tokenized consultation text into a shared transformer encoder. Input data is, for example, an array of integer IDs converted from a text “I am about to get sick due to continuous night shifts”. The encoder generates a high-dimensional hidden state tensor from an input sequence. The analysis unit inputs this hidden state tensor into a keyword extraction head, a summary generation decoder, and an emotion classification head, respectively. The emotion classification head performs pooling processing on the hidden state tensor, and outputs a score of each emotion parameter through a fully connected layer. Output data is an array of numerical values such as a negative emotion score of 0.85 and a turnover intention of 0.60, for example. The analysis unit inputs this score array into a threshold determination module, and sets a high risk flag when the score exceeds 0.8. The similar case search model uses the hidden state tensor as a query vector, and searches a vector database using an approximate nearest neighbor search algorithm. The similar case search model outputs countermeasure text of a past case having the highest similarity score as output data. The analysis unit integrates these output results, and generates a structured analysis result JSON object. The analysis unit transmits this object to the subsequent support guidance unit. Thereby, the system significantly reduces consumption of computing resources compared to a case of executing a plurality of independent models. The system shortens inference time, and enables real-time feedback generation. The system quantifies semantics of a complex natural language as multifaceted numerical indexes.

The support guidance unit has a function of automatically generating optimal feedback and advice for the nursing care staff member by the generative AI based on the determination result by the analysis unit and the countermeasure of the past case, and presenting the optimal feedback and advice on a screen of the terminal. For example, it presents specific and situation-dependent advice such as “Since the current situation is highly likely to be a serious mental burden, consultation with a psychologist or a care manager is recommended”, “In a similar past case, work shift adjustment and use of external counseling were effective”, “First, prioritize physical condition management, and taking a leave of absence can also be considered as necessary”, “There is a case that improved by receiving counseling by an external counselor”, or “There is a case where review of work sharing and a team building measure led to prevention of recurrence”. Furthermore, when the nursing care staff member desires or when the system determines it necessary, a support destination such as a psychologist, a care manager, a consultation desk, an external counselor, an industrial physician, an administrator, or an external expert is automatically specified, and the shortest possible interview date and time is automatically proposed in cooperation with the appointment management unit to confirm an appointment. For example, guidance such as “An interview with a psychologist is possible at 10:00 tomorrow. Do you want to confirm the appointment?” is displayed, and when the appointment is confirmed, a reminder notification is also performed. Specifically, the support guidance unit executes a conditional text generation algorithm. The support guidance unit receives the analysis result JSON object output from the analysis unit as input data. The input data includes the emotion score, the extracted keyword, and text of a recommended countermeasure. The support guidance unit embeds this input data into a prompt template, and inputs the prompt template into a large language model. The large language model autoregressively generates a token, and generates an advice character string of a natural language as output data. The output data is a character string such as “In a past case, shift adjustment was effective. An interview with a psychologist is possible at 10:00 tomorrow. Do you want to confirm the appointment?”, for example. The support guidance unit transmits control data of a UI component for triggering an appointment confirmation action to the terminal together with this character string. The terminal renders the text and an “appointment confirmation” button on the screen based on the received data. When a user clicks the button, the terminal transmits an API request for appointment confirmation to the server. The appointment management unit receives this request, and inserts a record into an appointment table of a database. The appointment management unit schedules processing of transmitting a reminder message to the terminal via a push notification service a certain time before the appointment date and time. Thereby, the system realizes a seamless transition to a specific problem-solving action, not limited to mere information presentation. The system minimizes operation steps of the user, and dramatically improves accessibility to support. The system prompts behavioral change of the user through an interactive interface.

The database management unit has a function of centrally managing various data handled in the entire system, such as consultation content, a session log, a past nursing care case, support destination information, an appointment history, report data, trend analysis data, multilingual support data, and image/file data. For example, a consultation history for each nursing care staff member is managed in chronological order so that past consultation content and a response history can be quickly referred to. In a past nursing care case database, consultation content, a countermeasure, a result, an involved support destination, a recurrence prevention measure, a period until resolution, a recurrence rate, staff satisfaction, presence or absence of follow-up, a business improvement proposal, a turnover prevention measure, and the like are recorded. For example, a detailed case such as “March 2024, night shift staff B consulted about ‘overwork’ and ‘poor physical condition’, improved by shift adjustment and psychologist interview, no recurrence” is stored. Specifically, the database management unit executes a polyglot persistence architecture combining a distributed relational database and a NoSQL database. The database management unit stores an appointment history and a user master, which are structured transaction data, in a table of the relational database. The database management unit saves consultation content text and an image file, which are unstructured data, in an object storage. The database management unit vectorizes text data of a past nursing care case, and stores the vectorized text data in a high-dimensional vector database. The database management unit executes a distributed transaction control protocol for maintaining data consistency among respective data stores. The database management unit replicates frequently accessed case data to an in-memory cache cluster in order to improve data read performance. The database management unit asynchronously executes data backup processing, and creates a replication in a plurality of geographically separated data centers. The database management unit executes a query optimizer, and optimizes an execution plan of an SQL query including a complex join condition and aggregation processing. Thereby, the system guarantees a search response speed in milliseconds even for petabyte-class large-scale data. The system eliminates a single point of failure, and realizes high availability and fault tolerance. The system integrally manages various data formats, and provides an advanced data analysis infrastructure.

The privacy protection unit has a function of anonymizing personal information of the nursing care staff member, and preventing information leakage to the inside and outside of the system. For example, a consulter ID is converted into a random token, and information capable of identifying an individual is not included in consultation content or a report. An access log and a database are also encrypted, and it is designed so that personal information cannot be accessed even with administrator privileges. In a report provided to a support destination, information is described in a format that cannot identify an individual, such as “Consulter: anonymous token 123456, Consultation content: I am about to get sick due to continuous night shifts, Emotion score: 0.87”. Specifically, the privacy protection unit executes one-way encryption processing using a hash function. The privacy protection unit converts input character string data of the consulter ID into a 256-bit fixed-length hash value. The privacy protection unit adds a random character string called a salt to the consulter ID. The privacy protection unit applies a secure hash algorithm to the character string after the salt addition. Thereby, the system improves resistance to a rainbow table attack. The privacy protection unit extracts a personal information entity from consultation content text using a natural language processing model. The natural language processing model includes a transformer architecture specialized for a named entity extraction task. An input to the natural language processing model is one-dimensional array data obtained by tokenizing the consultation content text. For example, input data includes tokens such as “Taro Yamada”, “Tokyo”, and “telephone number”. An output of the natural language processing model is a score array from 0 to 1 indicating a probability that each token corresponds to personal information. For example, output data indicates a score of 0.99 for a person name token. The privacy protection unit replaces a token whose score exceeds a predetermined threshold with a masking character string. The privacy protection unit transmits the text data after replacement to the database management unit. The system applies an advanced encryption standard algorithm to the entire storage area of the database. The system strictly stores an encryption key in a hardware security module. The system does not directly provide a decryption key even in response to an access request from an administrator. The system executes decryption processing in a secure enclave on a memory space. Thereby, the system physically and logically prevents information leakage due to a memory dump. As a technical effect, the system automates anonymization processing of personal information, and dramatically improves safety of data management. As a specific application field of the system, the system is optimal for an internal reporting system in a medical institution or a nursing care facility where strict privacy protection is required.

The user interface unit has a function of providing an intuitive input screen, a consultation history confirmation screen, a feedback and advice display screen, an appointment confirmation/change screen, a report browsing screen, and the like so that the nursing care staff member can easily access the system from the terminal. For example, it realizes various user experiences such as sequential question answering in a chatbot format, voice input support, an image and file attachment function, a draft saving function for consultation content, a search function for a past consultation history, and a feedback evaluation function. Specifically, the user interface unit controls data transmission and reception between the terminal and the server using an asynchronous communication protocol. The user interface unit adopts a single page application architecture. The user interface unit constructs a virtual document object model. The user interface unit optimizes drawing update of a screen using a state management library. The user interface unit calls a natural language understanding engine in order to provide a chatbot function. The natural language understanding engine classifies an intention of input text of the user using a recurrent neural network. An input to the natural language understanding engine is a word embedding vector sequence of the text input by the user. For example, input data is a multidimensional tensor obtained by vectorizing text such as “I forgot my password” or “I want to book an interview”. An output of the natural language understanding engine is a probability distribution vector for a predefined intention class. For example, output data indicates a probability of 0.85 for a “reservation request” class. The user interface unit dynamically generates next response text based on an intention class having the highest probability. The user interface unit executes a voice recognition model in order to provide a voice input function. The voice recognition model includes an acoustic feature amount extraction unit and a decoder unit. An input to the voice recognition model is a two-dimensional tensor obtained by converting voice waveform data acquired from a microphone into a mel-frequency cepstrum coefficient. An output of the voice recognition model is a sequence of recognized text character strings. The user interface unit reflects the recognized text in an input field in real time. The user interface unit executes image compression processing on a client side in an image attachment function. The user interface unit reduces a spatial frequency component of image data using a discrete cosine transform. Thereby, the system realizes high-speed file upload while suppressing consumption of a network bandwidth. As a technical effect, the system reduces an input load of the user, and improves responsiveness of the system. As a specific application field of the system, the system is applicable to a portal site of a large-scale organization having employees with various IT literacy.

The report generation unit has a function of automatically generating a detailed report including a summary of consultation content, an extracted keyword, an analysis result of emotion, a main point of a past case, recommended advice, appointment information, a follow-up proposal, a business improvement proposal, a turnover risk evaluation, and the like by generative AI, and providing the detailed report to a support destination or an administrator. For example, information enabling the support destination to respond quickly and accurately is comprehensively described, such as “The consulter has consulted three times in the past two weeks, and a negative emotion score is on an upward trend”, “Since a psychologist interview and work shift adjustment were effective in a similar past case, a similar response is recommended”, “Since anxiety regarding ICT equipment operation is strong, additional training by an expert is proposed”, or “When a work burden during a disaster is large, an increase in temporary staff is considered”. A specific example of a prompt sentence to be read by the generative AI includes “Create a detailed report for a support destination based on the following consultation content, emotion score, past case, and advice information.”. Specifically, the report generation unit generates natural language text from structured data using a large language model. The large language model includes a transformer decoder architecture having billions of parameters. The report generation unit integrates input data, and constructs a prompt character string. Input data to the report generation unit is a composite data structure including consultation content text, a floating-point numerical value of an emotion score, a character string array of an extracted keyword, and summary text of a past case. For example, input data includes elements such as “Emotion score: 0.85” and “Keyword: night shift, fatigue”. The report generation unit converts the prompt character string into a one-dimensional array of integer IDs using a tokenizer. The large language model receives the array of integer IDs as an input. The large language model calculates a dependency relationship between input tokens using a self-attention mechanism. An output of the large language model is a probability distribution vector for an entire vocabulary of a subsequent token. The report generation unit searches for a token sequence having the highest probability using a beam search algorithm. The report generation unit converts the generated token sequence into natural language text using a decoder. For example, output data is a logical sentence such as “The staff member has accumulated fatigue due to night shifts, and urgent shift adjustment is recommended”. The report generation unit maps the generated text to a predetermined report template. The report generation unit constructs a visual layout of a report using a hypertext markup language. The report generation unit converts the generated report into a portable document format. The report generation unit executes supervised fine-tuning in learning of the large language model. The system uses a report created by an excellent administrator in the past as correct answer data. The system calculates an error between an output of the model and the correct answer data using a cross-entropy error function. The system updates a weight parameter of the model using an error backpropagation method. As a technical effect, the system dramatically reduces report creation time by a human, and equalizes quality of report content. As a specific application field of the system, the system is applicable to a health management system in which a human resources department or an industrial physician monitors a health condition of an employee.

The appointment management unit has a function of managing a schedule of a support destination such as a psychologist, a care manager, a consultation desk, an external counselor, an industrial physician, an administrator, or an external expert, automatically proposing an optimal interview date and time according to a desire or a situation of the nursing care staff member, and performing confirmation, change, and cancellation of an appointment, a reminder notification, and the like. For example, it provides guidance such as “An interview with a psychologist is possible at 10:00 tomorrow” or “If you want to change the appointment date and time, please select a desired date and time from here”. Specifically, the appointment management unit searches for an optimal interview date and time using a constraint satisfaction problem solving algorithm. The appointment management unit acquires an array of free time slots from a calendar database of the support destination. The appointment management unit acquires a slot array of off-duty or break time from a work shift database of the nursing care staff member. The appointment management unit calculates a logical product of both time slot arrays, and generates a list of candidate times when an interview is possible. The appointment management unit scores the candidate time list using a machine learning-based recommendation model. The recommendation model adopts a gradient boosting decision tree algorithm. An input to the recommendation model is a feature amount vector indicating an attribute of a candidate time zone. For example, input data is a multidimensional vector including digitized feature amounts such as “day of the week”, “time zone”, “past interview participation history of staff member”, and “specialized field of support destination”. An output of the recommendation model is a score from 0 to 1 indicating a probability that each candidate time is accepted by the staff member. For example, output data indicates a score of 0.92 for “Friday 15:00”. The appointment management unit extracts top three candidate times having the highest scores. The appointment management unit transmits the extracted candidate times to the user interface unit. The appointment management unit executes transaction processing of a database when an appointment is confirmed. The appointment management unit completely prevents double booking using exclusive control. The appointment management unit automatically activates reminder processing 24 hours before the appointment date and time. The appointment management unit asynchronously transmits an e-mail or a push notification using a message queuing system. As a technical effect, the system completely automates complex schedule adjustment work, and improves an implementation rate of an interview. As a specific application field of the system, the system is applicable to an appointment management system of a medical institution or an interview adjustment system of a company in which a plurality of experts are involved.

The multilingual support unit has a function of realizing consultation reception, analysis, feedback, and report generation in multiple languages for a foreign staff member. The generative AI performs automatic translation and multilingual emotion analysis, responds to consultation in various languages such as English, Chinese, Korean, and Spanish, for example, and automatically generates appropriate feedback and advice for each language. For example, by using an English prompt such as “Please describe your workplace issue in detail. The system will analyze your input and provide advice.” or a Chinese prompt such as “ [symbol] [symbol] [symbol] , [symbol] [symbol] [symbol] ”, it is possible to respond to various language environments. Specifically, the multilingual support unit executes interlingual conversion of input text using a neural machine translation model. The neural machine translation model adopts a transformer architecture having an encoder-decoder structure. The multilingual support unit automatically identifies a source language of the input text using a language determination module. The language determination module is a support vector machine classifier using a character N-gram feature amount. An input to the language determination module is a text character string input by a user. An output of the language determination module is a label of an identified language code. For example, output data is a character string label such as “en” or “zh”. The multilingual support unit loads a weight parameter of an appropriate translation model into a memory based on the identified language code. An input to the neural machine translation model is a sequence of token IDs obtained by dividing text of the source language in subword units. The neural machine translation model maps an input sequence to a language-independent latent space vector using an encoder. The neural machine translation model autoregressively generates a token sequence of a target language from the latent space vector using a decoder. The multilingual support unit directly calculates an emotion score from source language text before translation using a multilingual emotion analysis model. The multilingual emotion analysis model is based on a multilingual pre-trained language model. Thereby, the system prevents a lack of nuance occurring in a translation process. The multilingual support unit retranslates generated feedback text into the target language, and transmits the retranslated feedback text to the user interface unit. As a technical effect, the system provides mental health support of uniform quality across language barriers, and improves a retention rate of foreign workers. As a specific application field of the system, the system is applicable to a human resources support desk of a multinational company or a global customer support system.

The trend analysis unit has a function of automatically analyzing a facility-wide harassment occurrence trend, a mental disorder occurrence rate for each department, a chronological change in consultation content, an effectiveness evaluation of a recurrence prevention measure, a prediction of a turnover risk, extraction of a business improvement proposal, and the like, and providing them as a dashboard or a report to a management layer or an administrative department. For example, it is possible to provide information useful for grasping an issue of an entire organization and planning a measure, such as “This month, mental burden consultation from night shift staff is on an upward trend”, “The most frequent consultation content in the past half year was ‘overwork’”, “An effect of a team building measure implemented as a recurrence prevention measure was high”, “Stress consultation after introduction of ICT equipment is increasing”, or “A turnover risk is increasing with an increase in a work burden during a disaster”. Specifically, the trend analysis unit models a stress trend of the entire organization using a time-series data analysis algorithm. The trend analysis unit extracts consultation log data for a certain past period from a database. The trend analysis unit aggregates the extracted data by department and by time frame, and constructs a multidimensional tensor. The trend analysis unit predicts the number of future consultations using an autoregressive integrated moving average model. The trend analysis unit executes a turnover risk prediction model. The turnover risk prediction model includes a deep neural network architecture. An input to the turnover risk prediction model is a feature amount vector including attribute data of each employee, a past consultation frequency, a moving average of an emotion score, and attendance data. For example, input data is a 50-dimensional vector having numerical elements such as “Age: 35”, “Monthly overtime hours: 45 hours”, and “Average negative score: 0.75”. An output of the turnover risk prediction model is a continuous value from 0 to 1 indicating a probability that the employee will leave a job within the next six months. For example, output data indicates a high turnover probability of 0.82. The trend analysis unit extracts a hidden topic distribution from consultation content text using a latent Dirichlet allocation method. The trend analysis unit calculates a transition of an appearance frequency of each topic. The trend analysis unit draws an analysis result as an interactive graph using a data visualization library. The trend analysis unit arranges a generated graph group on a dashboard screen. As a technical effect, the system discovers a potential problem of an organization at an early stage, and strongly supports data-driven management judgment. As a specific application field of the system, the system is applicable to an organizational condition grasping system of a retail business performing large-scale chain development or a manufacturing business having a large number of bases.

The image analysis unit has a function of analyzing image data and file data received from the consultation receiving unit and the user interface unit, performing handwritten character recognition, content summarization, emotion expression and situation grasping in an image, automatic classification of an evidence image, and the like, and integrating them with text data to execute comprehensive analysis. For example, various image and file information is targeted for analysis, such as “textizing an image of a letter received from a user by OCR and summarizing the content”, “extracting a keyword from an image of a memo in which complaint content is described”, “analyzing a daily stress tendency from a photograph of a business log”, and “extracting a problem in safety management from a photograph of a site”. As a specific example of a prompt sentence to be read by the generative AI, “Textize the following image data by OCR, summarize the content, and extract a main keyword.” is given. Specifically, the image analysis unit extracts a visual feature amount from an input image using a convolutional neural network. The image analysis unit executes an optical character recognition engine. The optical character recognition engine includes an architecture combining a region proposal network and a recurrent neural network. An input to the optical character recognition engine is a three-dimensional RGB tensor obtained by resizing and normalizing image data uploaded by a user. For example, the input data is a tensor having a resolution of 1024×1024 pixels and three channels. An output of the optical character recognition engine is a list of pairs of bounding box coordinates of characters included in the image and recognized text character strings. For example, the output data is structured data of “coordinates (10, 20, 100, 40), text: ‘complaint report’”. The image analysis unit inputs the extracted text data into the natural language processing model, and executes summarization and keyword extraction. The image analysis unit automatically categorizes the evidence image using an image classification model. The image classification model adopts a residual network architecture. An input to the image classification model is an image tensor. An output of the image classification model is a probability distribution vector for predefined classes such as “letter”, “site photograph”, and “screenshot”. The image analysis unit assigns a class with the highest probability as metadata of the image. The image analysis unit projects the image feature amount and the text feature amount into the same latent space using a multimodal learning model. The image analysis unit calculates a cosine similarity between both feature amounts, and evaluates relevance between the image and the text. As a technical effect, the system converts image information, which is unstructured data, into structured data, and dramatically improves accuracy and comprehensiveness of analysis. As a specific application field of the system, the system is applicable to a damage assessment system of an insurance company and a safety management system of a construction site.

As described above, in the system according to the present embodiment, the consultation receiving unit, the analysis unit, the support guidance unit, a database management unit, a privacy protection unit, a user interface unit, a report generation unit, an appointment management unit, a multilingual support unit, a tendency analysis unit, and the image analysis unit cooperate to seamlessly realize from consultation reception of a nursing care staff member to multifaceted analysis, optimal support guidance, data management, privacy protection, user experience improvement, automatic report generation, appointment management, tendency analysis, multilingual support, and image/file analysis, and by utilizing advanced natural language processing, emotion analysis, image analysis, tendency analysis, and multilingual support technology with the generative AI as a core, the system greatly contributes to improvement of mental health of staff members at a nursing care site, improvement of ease of working at the site, prevention of turnover, business improvement, and soundness of the entire organization. Specifically, the system adopts a microservice architecture and deploys each processing unit as an independent container. The system dynamically controls scaling of each processing unit using a container orchestration tool. The system realizes asynchronous communication between the processing units via a message broker. The system automatically activates a subsequent processing unit triggered by data update in a certain processing unit by an event-driven architecture. The system visualizes an execution path of a request across each processing unit using a distributed tracing technology. The system aggregates log data generated by each processing unit into a centralized log management infrastructure. The system utilizes a hardware accelerator dedicated to tensor calculation in order to optimize an inference pipeline of a machine learning model. The system reduces memory usage and calculation delay while maintaining inference accuracy using a model quantization technology. The system constructs a pipeline of continuous integration and continuous delivery, and enables rapid release of a new function. As a technical effect, the system integrates a plurality of complex AI models and data processing modules, and provides a robust platform having high availability and high scalability. As a specific application field of the system, the system is applicable to an integrated business system for enterprises that processes a huge amount of transactions and a large-scale cloud-based healthcare platform.

### Implementation Steps

### Step 1: Input and Reception of Consultation Content

A nursing care staff member accesses the system from a terminal such as a personal computer, a smartphone, a tablet, a wearable device, or a dedicated voice input terminal using a dedicated application, a web browser, a chatbot, a voice input interface, or the like, and inputs consultation content in a free description format. For example, the staff member can comprehensively input any worries, stress, and trouble that may occur at the site, such as abusive language and violence from a user, ignoring and backbiting from colleagues, exhaustion due to night shifts and excessive shifts, unreasonable complaints from a user's family, poor physical condition due to an increase in the amount of work, a sense of isolation in the workplace, difficulty in responding to nursing care refusal, a burden of guiding newcomers, difficulty in taking a vacation, a mental limit, insomnia, palpitations, unstoppable tears, difficulty in going to work, bullying in the workplace, power harassment, sexual harassment, moral harassment, burnout, communication failure with a user, deterioration of human relations in a team, trouble with an external contractor, overwork during an infectious disease epidemic, an emergency response burden during a disaster, and business confusion due to introduction of ICT equipment. In the case of voice input, it is also possible to perform voice recognition processing on the terminal side, convert it into text data, and transmit it to the server. An image attachment function and a file attachment function are also provided, and for example, “an image of a letter received from a user”, “a memo in which complaint content is described”, “an excerpt of a business log”, and the like can also be transmitted. The input consultation content is transmitted from the terminal to the server by encrypted communication, and is recorded as a session log together with information such as a staff ID (or an anonymous token), an input date and time, consultation content text, a terminal type, an IP address, position information (when permitted), a consultation category (when optional), and attached file information in the consultation receiving unit on the server side. Specifically, the terminal detects an input operation of the user and activates an event listener. The terminal temporarily stores the input text data in a buffer on a memory. When voice input is selected, the terminal activates a microphone device and samples voice waveform data. The terminal converts the voice waveform data into a spectrogram in a frequency domain using fast Fourier transform. The terminal executes a lightweight voice recognition model in the terminal using an edge computing technology. The terminal adds the recognized text data to the buffer. When an image file is attached, the terminal analyzes EXIF data of the image and deletes unnecessary metadata. The terminal serializes an input data group into one JSON format payload. The terminal establishes an encrypted communication channel with the server using a transport layer security protocol. The terminal securely exchanges a session key using a public key cryptography. The terminal encrypts the payload using a common key cryptography and transmits it to the server. The server receives a request via a load balancer. The server decrypts the received encrypted payload on a memory. The server parses the decrypted JSON data and verifies a data type of each field. The server inserts the successfully verified data into a session log table of a relational database. The server uses a prepared statement in insert processing to prevent an SQL injection attack. As a technical effect, the system integrates various input interfaces and constructs a secure and efficient data collection infrastructure. As a specific application field of the system, the system is applicable to a customer response system of a financial institution handling highly confidential information and an electronic medical record input system of a medical institution.

### Step 2: Multifaceted Analysis of Consultation Content by Generative AI

The analysis unit on the server side utilizes the generative AI to analyze the consultation content from multiple angles. First, a characteristic keyword (for example, “abusive language”, “violence”, “ignoring”, “overwork”, “user trouble”, “isolation”, “exhaustion”, “mental burden”, “burnout”, “complaint”, “nursing care refusal”, “shift problem”, “guidance burden”, “poor physical condition”, “insomnia”, “palpitations”, “unstoppable tears”, “difficulty in going to work”, “bullying”, “power harassment”, “sexual harassment”, “moral harassment”, “communication failure”, “deterioration of human relations”, “external outsourcing trouble”, “infectious disease”, “disaster response”, “ICT confusion”, etc.) is extracted from the consultation sentence by the natural language processing model, a summary of the entire consultation content is automatically generated by a summary generation model, and a plurality of emotion parameters such as a negative emotion score, a stress index, an anxiety level, a depressive tendency, anger, sadness, fear, a sense of helplessness, a sense of frustration, a sense of despair, an anger explosion risk, and a turnover intention are digitized by the emotion analysis model. As a specific example of a prompt sentence to be read by the generative AI, “Analyze the following consultation content, extract a main keyword, generate a summary sentence, and calculate an emotion score. Consultation content: ‘I am about to get sick due to continuous night shifts, but I cannot consult anyone.’” is given. Specifically, the analysis unit divides the input consultation content text into word tokens using a morphological analysis engine. The analysis unit collates each word token with a pre-learned word embedding matrix and converts it into a high-dimensional dense vector. The analysis unit executes a keyword extraction model. The keyword extraction model includes a bidirectional long short-term memory network architecture. An input to the keyword extraction model is a sequence of word vectors. An output of the keyword extraction model is a score array indicating a probability that each word is a keyword. The analysis unit extracts a word whose score exceeds a threshold value as a keyword. The analysis unit executes the summary generation model. The summary generation model is a transformer-based encoder-decoder model. An input to the summary generation model is a token ID sequence of the consultation content text. An output of the summary generation model is a token ID sequence of summary text. The analysis unit executes the emotion analysis model. The emotion analysis model is a deep neural network including a self-attention mechanism. An input to the emotion analysis model is a token ID sequence of the consultation content text. For example, the input data is an array including tokens such as “night shift”, “poor physical condition”, and “cannot consult”. An output of the emotion analysis model is a vector of continuous values for a plurality of emotion dimensions. For example, the output data is a multidimensional vector having numerical elements such as “depressive tendency: 0.88”, “anxiety level: 0.92”, and “anger: 0.15”. The analysis unit transmits the output emotion vector to the subsequent support guidance unit. The analysis unit executes these plurality of model inferences in parallel on a GPU cluster. As a technical effect, the system extracts a multidimensional structured feature amount from unstructured text at high speed and with high accuracy, and realizes objective situation evaluation independent of human subjectivity. As a specific application field of the system, the system is applicable to a call record analysis system of a call center and a flaming detection system of an SNS.

### Step 3: Analysis of Image and File Data

The image analysis unit analyzes image data and file data received from the consultation receiving unit and the user interface unit, performs handwritten character recognition, content summarization, emotion expression and situation grasping in an image, automatic classification of an evidence image, and the like, and integrates them with text data to execute comprehensive analysis. For example, various image and file information is targeted for analysis, such as “textizing an image of a letter received from a user by OCR and summarizing the content”, “extracting a keyword from an image of a memo in which complaint content is described”, “analyzing a daily stress tendency from a photograph of a business log”, and “extracting a problem in safety management from a photograph of a site”. As a specific example of a prompt sentence to be read by the generative AI, “Textize the following image data by OCR, summarize the content, and extract a main keyword.” is given. Specifically, the image analysis unit executes preprocessing on the input image data. The image analysis unit applies contrast enhancement and a noise removal filter of the image. The image analysis unit converts the image into grayscale and performs binarization processing. The image analysis unit executes a handwritten character recognition model. The handwritten character recognition model adopts a CRNN architecture combining a convolutional neural network and a recurrent neural network. An input to the handwritten character recognition model is a preprocessed binarized image tensor. For example, the input data is a one-dimensional image slice having a height of 32 pixels and a variable width. An output of the handwritten character recognition model is a text character string decoded using a connectionist temporal classification loss function. For example, the output data is a character string “Thank you for your continued support”. The image analysis unit inputs the extracted text into a natural language processing pipeline. The image analysis unit executes a scene understanding model. The scene understanding model includes a vision transformer architecture. An input to the scene understanding model is a sequence of patch embedding vectors obtained by dividing the image into patches of a fixed size. An output of the scene understanding model is caption text explaining an object and a situation in the image. For example, the output data is text “scattered documents and a fallen chair”. The image analysis unit combines the extracted text data and image caption data to generate an integrated text vector. The image analysis unit inputs the integrated text vector into the emotion analysis model of the analysis unit. As a technical effect, the system digitizes a physical situation and non-verbal information at a site that cannot be fully captured only by text information, and greatly expands a context of analysis. As a specific application field of the system, the system is applicable to a defective product detection system in a manufacturing industry and a property state assessment system in a real estate industry.

### Step 4: Collation With Past Case Database and Similar Case Extraction

The analysis unit searches for a case having a keyword matching or similar to the consultation content from a past nursing care site case database accumulated in a facility using a similar case search model of the generative AI, and extracts a past countermeasure and result, a recurrence prevention measure, staff satisfaction, presence or absence of follow-up, a business improvement proposal, a turnover prevention measure, and the like. For example, a similar case and its countermeasure are automatically extracted, such as “In a past case where abusive language and ignoring from a user occurred simultaneously, consultation with a psychologist, work shift adjustment by a care manager, and use of external counseling were effective”, or “In a case of exhaustion due to a night shift burden and an excessive amount of work, shift adjustment, review of business sharing, and a regular follow-up interview were implemented, leading to recurrence prevention”. As a specific example of a prompt sentence to be read by the generative AI, “Search a database for a past case similar to the following consultation content and keyword, and summarize a countermeasure and a result. Consultation content: ‘I am getting sick due to continuous night shifts.’ Keyword: ‘night shift’, ‘poor physical condition’” is given. Specifically, the analysis unit executes a high-speed similarity search using a vector database. The analysis unit inputs the current consultation content text into a sentence embedding model. The sentence embedding model is a pre-learned transformer encoder. An input to the sentence embedding model is a token sequence of the consultation content text. An output of the sentence embedding model is a fixed-length multidimensional dense vector expressing a semantic meaning of the text. For example, the output data is a 768-dimensional floating-point array. The analysis unit transmits this dense vector as a query vector to the vector database. The vector database similarly vectorizes and stores all past case texts. The vector database calculates a cosine similarity between the query vector and each vector in the database using an approximate nearest neighbor search algorithm. The vector database returns top N past case IDs having the highest similarity score. The analysis unit extracts detailed data of the case from a relational database using the acquired past case ID as a key. The analysis unit inputs a countermeasure text group of the extracted past case into the summary generation model. The summary generation model extracts a common effective pattern from a plurality of countermeasures to generate integrated text. For example, the output data is text “A combination of shift adjustment and a psychologist interview shows the highest improvement rate”. The analysis unit transmits the extracted similar case data and summary text to the support guidance unit. As a technical effect, the system realizes an advanced search based on a contextual meaning instead of simple keyword matching, and effectively reuses past tacit knowledge. As a specific application field of the system, the system is applicable to a past precedent search system of a law firm and a troubleshooting system of an IT help desk.

### Step 5: Automatic Generation and Presentation of Feedback and Advice

The support guidance unit automatically generates optimal feedback and advice for the nursing care staff member by the generative AI based on a determination result by the analysis unit and the countermeasure of the past case, and presents them on a screen of the terminal. For example, specific and situation-dependent advice is presented, such as “Since there is a high possibility that the current situation is a serious mental burden, consultation with a psychologist or a care manager is recommended”, “In a past similar case, work shift adjustment and use of external counseling were effective”, “First, prioritize physical condition management, and taking a leave of absence can also be considered as necessary”, and “There is a case that improved by receiving counseling by an external counselor”. As a specific example of a prompt sentence to be read by the generative AI, “Generate optimal feedback and advice for a nursing care staff member based on the following consultation content, emotion score, and past case information. Consultation content: ‘I am about to get sick due to continuous night shifts, but I cannot consult anyone.’ Emotion score: 0.85 Past case: ‘Shift adjustment and a psychologist interview were effective’” is given. Specifically, the support guidance unit utilizes a rule-based inference engine and a large language model in a hybrid manner. The support guidance unit evaluates the emotion score vector received from the analysis unit. The support guidance unit determines whether or not the emotion score exceeds a predefined danger threshold value. For example, when the negative emotion score exceeds 0.9, the support guidance unit sets an emergency response flag. The support guidance unit dynamically constructs a prompt using a prompt template engine. Input data to the support guidance unit is a structured JSON object including the consultation content text, the emotion score vector, the summary text of the extracted similar case, and a state of the emergency response flag. The support guidance unit converts this JSON object into a prompt character string of a natural language. The support guidance unit inputs the constructed prompt into the large language model. An output of the large language model is empathetic and specific advice text to be directly presented to the nursing care staff member. For example, the output data is text “Thank you for consulting us in a difficult situation. According to past data, many people who got sick due to night shifts like you have improved their situation by shift adjustment and an interview with an expert. Would you like to book an interview first?”. The support guidance unit transmits the generated text to the user interface unit. The user interface unit asynchronously renders the received text on the screen of the terminal. As a technical effect, the system achieves both an objective solution based on data and human-like empathetic communication, and lowers a psychological hurdle of the user. As a specific application field of the system, the system is applicable to an online medical consultation platform and a student counseling system of an educational institution.

### Step 6: Specification of Support Destination and Automatic Setting of Appointment

When the nursing care staff member desires or when the system determines that it is necessary, the support guidance unit automatically specifies a support destination such as a psychologist, a care manager, a consultation desk, an external counselor, an industrial physician, an administrator, or an external expert, and the appointment management unit searches a schedule of the support destination, automatically proposes a date and time when an interview is possible in the shortest time, and collates it with convenience of the staff member to confirm a reservation. For example, guidance such as “An interview with a psychologist is possible at 10:00 tomorrow. Do you want to confirm the reservation?” is displayed, and when the reservation is confirmed, a reminder notification is also performed. Specifically, the support guidance unit determines an optimal person in charge of the support destination using a matching algorithm. The support guidance unit calculates a cosine similarity between a keyword vector extracted from the consultation content and a specialized field vector of each support destination. The support guidance unit selects a support destination having the highest similarity as a first candidate. The appointment management unit calls a calendar API of the selected support destination and acquires an array of free time slots. The appointment management unit issues a query to an attendance management database of the staff member and acquires an array of off-duty time slots of the staff member. The appointment management unit calculates an intersection of both time slot arrays and generates a list of dates and times when an interview is possible. The appointment management unit transmits the date and time list to the user interface unit. The user interface unit draws the date and time list as an interactive calendar widget on the terminal screen. When the user selects a specific date and time, the terminal transmits a reservation confirmation request to the server. The appointment management unit starts a transaction for the database and inserts a reservation record. When the transaction is successfully committed, the appointment management unit updates the schedule of the support destination through the calendar API. The appointment management unit registers a reminder transmission job in an asynchronous task queue. The job scheduler executes the job before a designated time of the reservation date and time, and transmits an e-mail or a push notification. As a technical effect, the system completely automates a complex process from matching with an expert to schedule adjustment, and prevents a delay in intervention. As a specific application field of the system, the system is applicable to a business negotiation matching system between a sales representative and a customer and a mediation platform between a freelancer and a project.

### Step 7: Automatic Generation of Report and Advance Provision to Support Destination

The report generation unit automatically generates a detailed report including a summary of the consultation content, an extracted keyword, an emotion analysis result, a main point of a past case, recommended advice, appointment information, a follow-up proposal, a business improvement proposal, a turnover risk evaluation, and the like by the generative AI, and provides the detailed report to the support destination and the administrator. For example, information that enables the support destination to respond quickly and accurately is comprehensively described, such as “The consulter has consulted three times in the past two weeks, and the negative emotion score is on an upward trend”, and “In a past similar case, a psychologist interview and work shift adjustment were effective, so a similar response is recommended”. As a specific example of a prompt sentence to be read by the generative AI, “Create a detailed report for a support destination based on the following consultation content, emotion score, past case, and advice information.” is given. Specifically, the report generation unit executes data aggregation processing and collects related data from each module in the system. The report generation unit integrates the collected data into one hierarchical JSON document. The report generation unit embeds this JSON document into an input prompt of the large language model. An input to the large language model is a text sequence of thousands of tokens combining structured data and an instruction sentence of a natural language. An output of the large language model is report text structured in a markdown format. For example, the output data is text such as “# Summary\n The staff member is in a state where a turnover risk is extremely high. \n# Recommended Action\n1. Please conduct a hearing without a direct boss.” The report generation unit converts the markdown text into a web page format using an HTML parser. The report generation unit inputs the converted HTML data into a PDF generation engine and creates a printable document. The report generation unit encrypts the generated report data and stores it in a secure object storage. The report generation unit transmits a notification including a temporary URL for browsing the report to the terminal of the support destination. The system requests multi-factor authentication when accessing the temporary URL. As a technical effect, the system instantaneously creates a high-quality material for a supporter to completely grasp a situation before an interview, and dramatically improves quality and efficiency of the interview. As a specific application field of the system, the system is applicable to an automatic report generation system for a client of a consulting firm and a referral letter creation system of a medical institution.

Step 8: Privacy Protection Processing and Data Management A privacy protection unit anonymizes personal information of a nursing care staff member, and prevents information leakage to the inside and outside of the system. For example, a consulter ID is converted into a random token, and information capable of identifying an individual is not included in consultation content or a report. A database management unit centrally manages various data handled in the entire system, such as the consultation content, a session log, a past nursing care case, support destination information, an appointment history, report data, trend analysis data, multilingual support data, and image/file data, and thoroughly enforces access authority and encryption processing. Specifically, the privacy protection unit executes a data masking pipeline. The privacy protection unit specifies the personal information in text by combining regular expression matching and a named entity recognition model. The privacy protection unit replaces the specified character string with an irreversible hash value or a general-purpose placeholder. The privacy protection unit stores a log of replacement processing in a secure area as an audit trail. The database management unit operates a relational database management system and a NoSQL database in a hybrid manner. The database management unit stores structured data in the relational database, and stores unstructured text and image data in the NoSQL database. The database management unit realizes data protection at a storage level using a transparent data encryption technology. The database management unit implements a role-based access control model. The database management unit strictly defines the access authority at a table or column level according to a role of each user. The database management unit cooperates with an intrusion detection system that monitors all database queries and detects an abnormal access pattern. The database management unit automatically executes a full backup and an incremental backup of data periodically. As a technical effect, the system guarantees integrity and confidentiality of confidential data, and provides a robust data infrastructure satisfying compliance requirements. As a specific application field of the system, the system is applicable to a financial system or a medical information system that needs to comply with strict regulations such as the Personal Information Protection Law and HIPAA.

Step 9: Trend Analysis, Multilingual Support, and Company-wide Utilization A trend analysis unit automatically analyzes a facility-wide harassment occurrence trend, a mental disorder occurrence rate for each department, a chronological change in consultation content, an effectiveness evaluation of a recurrence prevention measure, a prediction of a turnover risk, extraction of a business improvement proposal, and the like, and provides them to a management layer or a management department as a dashboard or a report. A multilingual support unit realizes consultation receiving, analysis, feedback, and report generation in multiple languages for foreign staff members, and generative AI performs automatic translation and multilingual emotion analysis. For example, by using an English prompt such as “Please describe your workplace issue in detail. The system will analyze your input and provide advice.” or a Chinese prompt such as “ [symbol] [symbol] [symbol] , [symbol] [symbol] [symbol] ”, it is possible to cope with diverse language environments. Specifically, the trend analysis unit constructs an online analytical processing cube, and speeds up multidimensional data aggregation. The trend analysis unit groups departments or facilities having similar consultation trends using a clustering algorithm. The trend analysis unit executes a K-means algorithm, and calculates a centroid vector of each group. The trend analysis unit detects a rapid increase in the number of consultations largely deviating from a past trend in real time using an anomaly detection algorithm. The trend analysis unit push-notifies a detection result to a dashboard of an administrator as an alert. The multilingual support unit specifies a source language from a character code and an N-gram feature amount of input text using a language determination model. The multilingual support unit dynamically provisions a container of a translation model corresponding to the specified language. The multilingual support unit converts the text into Japanese or English, which is a common language inside the system, using the translation model. After executing analysis processing in the common language, the system back-translates a result into a target language again. The multilingual support unit also includes a mode of performing inference in a native language space without translation by directly using a multilingual large language model. As a technical effect, the system simultaneously realizes visualization of a macro organizational issue and micro diversity support, and strongly supports global organizational management. As a specific application field of the system, the system is applicable to an integrated personnel platform of a global company having multinational employees or an activity support system of an international NGO.

### Specific Use Case

For example, when a nursing care staff member simultaneously has a plurality of stress factors such as exhaustion due to continuous night shifts, abusive language from a user, ignoring from a colleague, poor physical condition due to an increase in the amount of work, a sense of isolation in a workplace, an unreasonable complaint from a family member, and business confusion due to introduction of ICT equipment, the staff member accesses the nursing care site support system of the present invention from a terminal such as a personal computer or a smartphone, and inputs consultation content in a free description format, such as “I am about to get sick due to continuous night shifts, but I cannot consult anyone. It is painful to receive abusive language from a user. Recently, I am ignored by my colleagues and isolated. I feel stressed because I do not understand how to operate a new system. There are many complaints from family members, and I feel mentally at my limit.” Voice input and image attachment are also possible, and for example, “an image of a letter received from a user”, “a memo describing complaint content”, “an excerpt from a business log”, and the like can also be transmitted at the same time. A consultation receiving unit records such information as a session log together with a staff ID or an anonymous token, an input date and time, a terminal type, a consultation category, attached file information, and the like. Specifically, the terminal receives a user input via a single-page application operating on a web browser. The terminal converts an input text character string into a byte array by UTF-8 encoding. When the voice input is used, the terminal acquires a voice stream in a PCM format from a microphone using a Web Audio API. The terminal divides the voice stream into chunks of a certain time, and streaming-transmits the chunks to a server in real time using WebSocket communication. The server sequentially inputs the streamed voice data into a voice recognition model, and converts the voice data into text. When an image file is selected, the terminal reads image data into a memory using a FileReader API. The terminal encodes the image data into a character string in a Base64 format. The terminal combines text data, voice recognition result text, and the Base64-encoded image data into one JSON object. The terminal transmits the JSON object to a RESTful API endpoint of the server using a POST method of HTTPS. The consultation receiving unit of the server extracts an authentication token from a request header, and executes JWT verification processing. When the verification is successful, the consultation receiving unit parses data in a payload. The consultation receiving unit acquires a connection from a connection pool of a relational database, and executes an insert query. As a technical effect, the system allows inputs in diverse modalities for a user having complex stress factors, and prevents a loss of data collection. As a specific application field of the system, the system is applicable to an emergency reporting system at the time of a disaster or a platform of a local government that receives a multimedia report from a citizen.

An analysis unit analyzes received consultation content from multiple angles using generative AI. First, a natural language processing model extracts keywords such as “night shift”, “poor physical condition”, “abusive language”, “ignoring”, “isolation”, “complaint”, “ICT confusion”, “stress”, and “mental limit”, and a summary generation model automatically generates a summary sentence such as “Mental and physical burdens are increasing due to night shifts, an increase in the amount of work, abusive language and complaints from users and family members, ignoring from colleagues, and stress of operating a new system”. An emotion analysis model calculates a high negative emotion score (for example, 0.92) from expressions such as “painful”, “limit”, “isolation”, and “stress”, and highly evaluates a mental burden and a turnover risk. An image analysis unit converts an image of an attached letter or memo into text by OCR, summarizes content, and extracts a main keyword. Specific examples of a prompt sentence to be read by the generative AI include “Analyze the following consultation content, extract a main keyword, generate a summary sentence, and calculate an emotion score. Consultation content: ‘I am about to get sick due to continuous night shifts, but I cannot consult anyone. It is painful to receive abusive language from a user. Recently, I am ignored by my colleagues and isolated. I feel stressed because I do not understand how to operate a new system. There are many complaints from family members, and I feel mentally at my limit.’” and “Convert the following image data into text by OCR, summarize content, and extract a main keyword.” Specifically, the analysis unit divides input long text into individual sentences using a sentence boundary detection algorithm. The analysis unit inputs each sentence into a transformer-based encoder, and extracts a feature amount vector in units of sentences. The analysis unit applies a conditional random field model in a keyword extraction task, and scores importance of a word depending on a context. The analysis unit adopts a pointer-generator network in a summary generation task. The summary generation model dynamically switches between a mechanism of directly copying an important word in the input text and a mechanism of generating an unknown word. The emotion analysis model learns a non-linear mapping from the sentence feature amount vector to an emotion dimension using a multilayer perceptron. An input to the emotion analysis model is a 768-dimensional sentence feature amount vector. An output of the emotion analysis model is a probability value vector in a range of 0 to 1 that has passed through a softmax function. For example, output data indicates extremely high scores of “turnover risk: 0.95” and “depression: 0.88”. The image analysis unit applies an edge detection filter to the attached image data, and emphasizes an outline of a character region. The image analysis unit executes an OCR engine using a long short-term memory network, and decodes a text character string from the image. The analysis unit combines the text extracted by the OCR with the original consultation content text, and recalculates an integrated context vector. As a technical effect, the system accurately decomposes and quantifies a structure of a complexly intertwined problem by pipelining a plurality of AI models. As a specific application field of the system, the system is applicable to an initial triage system for legal consultation handling a complex case or an online medical questionnaire system in psychiatry.

The analysis unit further searches for a plurality of cases having a keyword matching or similar to “night shift”, “poor physical condition”, “abusive language”, “ignoring”, “isolation”, “complaint”, “ICT confusion”, or the like by referring to a past nursing care site case database, and automatically extracts a similar case and a countermeasure thereof, such as “In a case of exhaustion due to a night shift burden or an excessive amount of work, shift adjustment, review of business sharing, and a regular follow-up interview were effective”, “In a case where abusive language and complaints from users and family members continued, use of a psychologist interview or external counseling, and strengthening of family support by an administrator were effective”, “In a case of ignoring or a sense of isolation from colleagues, a team building measure or group counseling was effective”, or “In a stress consultation at the time of introducing ICT equipment, additional training by an expert or introduction of a peer support system was effective”. A specific example of a prompt sentence to be read by the generative AI includes “Search a database for a past case similar to the following consultation content and keywords, and summarize a countermeasure and a result. Consultation content: ‘I am getting sick due to continuous night shifts. It is painful to receive abusive language from a user.’ Keywords: ‘night shift’, ‘poor physical condition’, ‘abusive language’”. Specifically, the analysis unit constructs a Boolean search query and a vector search query in a hybrid manner using a plurality of extracted keyword groups. The analysis unit issues the Boolean search query to a full-text search engine using an inverted index, and narrows down a case group including an exact match of a keyword at high speed. The analysis unit calculates a semantic similarity for the narrowed-down case group using a vector search engine. The analysis unit calculates an inner product of a sentence embedding vector of the consultation content and a sentence embedding vector of each past case. The analysis unit sorts the past cases in descending order based on an inner product score. The analysis unit extracts top five pieces of past case data. The analysis unit inputs countermeasure text of the extracted past cases into a context window of a large language model. An input to the large language model is a prompt in which current consultation content text and five pieces of past case text are concatenated. An output of the large language model is summary text of a countermeasure reconstructed into a form applicable to a current situation by extracting a common success factor from the plurality of past cases. For example, output data is logical text such as “When night shift fatigue and human relationship trouble are combined as in this case, a step-by-step approach of prioritizing physical fatigue recovery by shift adjustment first and then introducing a psychologist interview has shown an improvement rate of 80% or more in past cases”. The analysis unit transmits the summary text to a subsequent report generation unit and support guidance unit. As a technical effect, the system dynamically synthesizes a solution most suitable for a current complex situation from a huge amount of accumulated past data, and improves quality of decision-making. As a specific application field of the system, the system is applicable to a treatment policy determination support system based on a past case in a medical institution or a recovery procedure presentation system based on a past failure response history in a manufacturing industry.

A support guidance unit automatically generates specific and situation-dependent feedback and advice by generative AI based on a determination result by an analysis unit and a countermeasure of a past case, such as “Since there is a high possibility that a current situation is a serious mental burden, consultation with a psychologist or a care manager is recommended”, “In a past similar case, work shift adjustment, use of external counseling, and additional training by an expert were effective”, “First, physical condition management is prioritized, and a leave of absence can be considered as necessary”, or “It is recommended to request an administrator to strengthen family support”, and presents the feedback and the advice on a screen of a terminal. A specific example of a prompt sentence to be read by the generative AI includes “Generate optimal feedback and advice for a nursing care staff member based on the following consultation content, emotion score, and past case information. Consultation content: ‘I am about to get sick due to continuous night shifts, but I cannot consult anyone. It is painful to receive abusive language from a user.’ Emotion score: 0.92 Past case: ‘Shift adjustment and a psychologist interview were effective’”. Specifically, the support guidance unit executes a large language model based on a transformer architecture. The system converts an input prompt character string into an integer token ID sequence using a tokenizer. The system maps the token ID sequence to a high-dimensional word embedding vector. For example, the system generates a floating-point number vector having 1024 dimensions. The large language model calculates a contextual dependency between input vectors using a self-attention mechanism. Input data to the large language model includes a text tensor of the consultation content, a numerical vector indicating the emotion score, and a text vector of the past case. Specific examples of the input data include a word token sequence of the consultation content, a scalar value obtained by normalizing the emotion score of 0.92, and a summary text vector of the past case. The large language model combines these pieces of input data, and passes them through a multi-layer neural network layer. The large language model generates a probability distribution of a next following word as an output. The system sequentially selects a token having the highest probability from the probability distribution. The system decodes the selected token sequence, and generates advice text in a natural language. A format of output data is structured data including character string data and a generation certainty score of each word. Specific examples of the output data include a text token sequence “consultation with a psychologist is recommended” and a numerical value of 0.95 indicating a certainty thereof. The support guidance unit transfers the generated text data to a subsequent processing module. The subsequent processing module binds the text data to a display user interface component of the terminal. The terminal renders the bound data on the screen. The system replaces a conventional operation in which a human counselor manually searches for a past case and creates advice. The system instantaneously generates highly accurate advice capturing a fine nuance of a context by an operation in a high-dimensional vector space. With this configuration, the system dramatically improves a response speed. The system optimizes utilization efficiency of computing resources. The technology exhibits a technical effect of enabling real-time intervention in a specific application field such as a mental health support system for a medical worker or a nursing care staff member.

When a nursing care staff member desires an interview with a support destination, an appointment management unit searches a schedule of the support destination such as a psychologist, a care manager, or an external counselor, automatically proposes the earliest possible date and time for the interview, and confirms a reservation by checking against convenience of the staff member. For example, guidance such as “An interview with a psychologist is possible at 10:00 tomorrow. Do you want to confirm the reservation?” is displayed, and when the reservation is confirmed, a reminder notification is also performed. Specifically, the appointment management unit executes a schedule optimization algorithm. The system expands a desired condition of the staff member and free time of the support destination on a memory as a multidimensional array. The system issues an SQL query to a schedule database. The system extracts schedule data of the support destination for the next one month. The system converts the extracted schedule data into a binary matrix for each time frame. The appointment management unit formulates schedule adjustment as a constraint satisfaction problem. The system calculates an inner product of a desired time zone vector of the staff member and a free time matrix of the support destination. The system calculates a matching score. The system extracts a time frame in which the matching score exceeds a preset threshold as a candidate. The system sorts an extracted candidate list in order of fitness. The system generates a candidate list of an optimal date and time. The system outputs the candidate list as structured data in a JSON format. Specific examples of output data include a timestamp of an interview date and time, an identifier of the support destination, and a numerical value of a fitness score. The system transmits the output structured data to a user interface generation unit. The user interface generation unit analyzes the structured data, and displays a reservation confirmation dialog on a screen of a terminal. The terminal detects a reservation confirmation input from a user. The terminal transmits a confirmation signal to a server. The server updates a flag of a corresponding time frame in a database to reserved. The server registers a reminder notification job in an asynchronous task queue. The system generates a push notification payload several hours before a designated date and time. The system transmits the push notification payload to the terminal. With this configuration, the system eliminates a communication overhead when a human adjusts a schedule by telephone or email. The system improves throughput of the entire system. The system executes parallel computing for simultaneously processing a plurality of constraint conditions. The technology exhibits a technical effect of minimizing a delay in reservation processing in a specific application field such as automation of resource allocation in a large-scale organization or a reservation system for online medical treatment.

A report generation unit automatically generates a detailed report including a summary of consultation content, an extracted keyword, an emotion analysis result, a main point of a past case, recommended advice, appointment information, a follow-up proposal, a business improvement proposal, a turnover risk evaluation, and the like by generative AI, and provides the detailed report to a support destination or an administrator. A specific example of a prompt sentence to be read by the generative AI includes “Create a detailed report for a support destination based on the following consultation content, emotion score, past case, and advice information.” Specifically, the report generation unit executes a fine-tuned large language model. The system integrates heterogeneous data output from a plurality of modules. The system concatenates summary text, a list of keywords, a floating-point number of an emotion score, and a probability value of a turnover risk. The system converts the concatenated data into a single input tensor. The system supplies the input tensor to an input layer of the large language model. Specific examples of input data include a text vector of the consultation content, a turnover risk probability value of 0.85, and a summary vector of the past case. The large language model is learned in advance using a cross-entropy error function. The large language model processes the input tensor by a multi-layer self-attention network. The large language model generates a text token sequence of each section. The large language model outputs structured text data in a Markdown format or an HTML format. A format of output data is character string data including a heading tag, a paragraph tag, and a list tag. Specific examples of the output data include bulleted text of a business improvement proposal and a numerical table indicating an emotion analysis result. The report generation unit transfers the output structured text data to a subsequent PDF generation module. The PDF generation module analyzes the text data, and applies a visual layout. The PDF generation module generates a document file in a binary format. The system transmits the generated document file to a terminal of the administrator using a secure communication protocol. The system integrates a wide variety of data formats, and automatically generates a single structured report. The system eliminates an operation in which a human collects data from a plurality of systems and manually creates a report. The system improves calculation efficiency of data aggregation processing. The system reduces CPU cycles required for report generation. The technology exhibits a technical effect of speeding up visualization and sharing of information in a specific application field such as a personnel and labor management system or a compliance audit system.

A privacy protection unit converts a consulter ID into a random token, and performs processing so that information capable of identifying an individual is not included in consultation content or a report. A database management unit centrally manages the consultation content, a session log, a past nursing care case, support destination information, an appointment history, report data, trend analysis data, multilingual support data, image/file data, and the like, and thoroughly enforces access authority and encryption processing. Specifically, the privacy protection unit executes a cryptographic hash function. The system converts the consulter ID into a unique hash value using a SHA-256 algorithm. The system combines the hash value with a random salt value, and generates an irreversible anonymous token. The system executes a named entity recognition model based on natural language processing. The named entity recognition model receives a text tensor of the consultation content as an input. Specific examples of input data include a word token sequence including a name of a consulter, a facility name, and a specific place name. The named entity recognition model calculates a probability value of whether each token belongs to a personal information class. The named entity recognition model executes a binary classification task. A format of output data is an array of floating-point numbers from 0 to 1 for each token. A specific example of the output data includes a high probability value of 0.98 for a specific name token. The system specifies a token whose probability value exceeds a preset threshold. The system replaces the specified token with a masking character string such as an asterisk. The system transmits masked text data to the database management unit. The database management unit executes a relational database system. The database management unit encrypts stored data using an AES-256 encryption algorithm. The system applies a role-based access control mechanism. The system restricts access to data according to an authority level of a user. The system reduces a data leakage risk. The system reduces a calculation load required for data preprocessing by automating masking processing. The system eliminates an inefficient operation of checking personal information visually by a human. The technology exhibits a technical effect of achieving both high security and privacy protection in a specific application field such as a medical information system or a customer management system of a financial institution.

A trend analysis unit automatically analyzes a facility-wide harassment occurrence trend, a mental disorder occurrence rate for each department, a time-series change in consultation content, an effectiveness evaluation of a recurrence prevention measure, a prediction of a turnover risk, extraction of a business improvement proposal, and the like, and provides them as a dashboard or a report to a management layer or a management department. A multilingual support unit realizes consultation receiving, analysis, feedback, and report generation in multiple languages for foreign staff members, and the generative AI performs automatic translation and multilingual emotion analysis. For example, by using an English prompt such as “Please describe your workplace issue in detail. The system will analyze your input and provide advice.” or a Chinese prompt such as “ [symbol] [symbol] [symbol] , [symbol] [symbol] [symbol] ”, it is possible to cope with diverse language environments. Specifically, the trend analysis unit executes a time-series analysis model based on a long short-term memory network. The system extracts the number of consultations, an average value of emotion scores, and a transition of the number of turnovers in the past few months. The system converts these data into a feature vector for each time step. The time-series analysis model receives a sequence of the feature vectors as an input. Specific examples of the input data include an integer array indicating the number of monthly harassment consultations in the past six months, and a floating-point number array indicating a stress score for each department. The time-series analysis model learns a time-series dependency while updating a hidden state vector. The time-series analysis model outputs a predicted probability value of the turnover risk in a specific future period. A format of the output data is a numerical vector including a turnover prediction score of each department. A specific example of the output data includes a probability value of 0.75 indicating the turnover risk of the next month in a specific department. The system converts the prediction score into a data structure for drawing a graph on the dashboard. The system transmits the converted data to an administrator's terminal. Furthermore, the multilingual support unit executes a multilingual-supported transformer model. The system tokenizes a foreign language text input. The system projects a token sequence into a common multidimensional vector space. The system generates a language-independent intermediate vector representation. The system decodes a text token sequence of a translation destination from the intermediate vector representation. The system transfers a translation result to the analysis unit. The system detects a minute change that is difficult for a human to notice by analyzing multidimensional time-series data. The system improves prediction accuracy. The system eliminates the need to hold an individual model for each language on a memory by performing multilingual processing in the common vector space. The system significantly reduces memory usage. The present technology exhibits a technical effect of supporting data-driven decision making in specific application fields such as an employee management system of a global company and a multinational customer support platform.

As described above, the nursing care site support system of the present invention realizes everything from consultation receiving to analysis by multifaceted generative AI, automatic analysis of image/file data, collation with a past case database, automatic generation of optimal feedback and advice, support destination guidance and automatic setting of an appointment, automatic generation of a report, privacy protection, trend analysis, and multilingual support in an integrated manner, and greatly contributes to improvement of mental health of a nursing care staff member, improvement of ease of working at a site, prevention of turnover, business improvement, and soundization of the entire organization. Specifically, the system executes an integrated data pipeline based on a microservice architecture. The system deploys each processing module as an independent container. The system controls asynchronous communication between the modules via an API gateway. The system publishes raw data input from a consultation receiving module to a message queue. The system causes an analysis module, a generation module, and a trend analysis module to function as subscribers. The system executes data processing in parallel in each module. The system aggregates processing results into a central in-memory data grid. The system generates final feedback and a report using the aggregated data. The system optimizes a data flow between the respective modules. The system lowers a degree of module coupling of the entire system. The system improves dynamic scalability according to an increase or decrease in traffic. The system minimizes a data conversion overhead in each processing phase. The system reduces an end-to-end processing delay. The system does not merely imitate a human mental process. The system uses computer-specific technologies of high-dimensional vector calculation, a parallel processing cluster, and integration of a plurality of machine learning models. The system realizes real-time and highly accurate support that has been impossible in the past. The present technology exhibits a technical effect of bringing about efficient operation of system resources and maximization of processing capacity in specific application fields such as a company-wide mental health management platform in a large-scale nursing care facility group and a staff support system in a wide-area medical network. The system instantly processes an enormous amount of data beyond physical constraints of hardware, and automatically triggers a specific action toward soundization of the entire organization.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

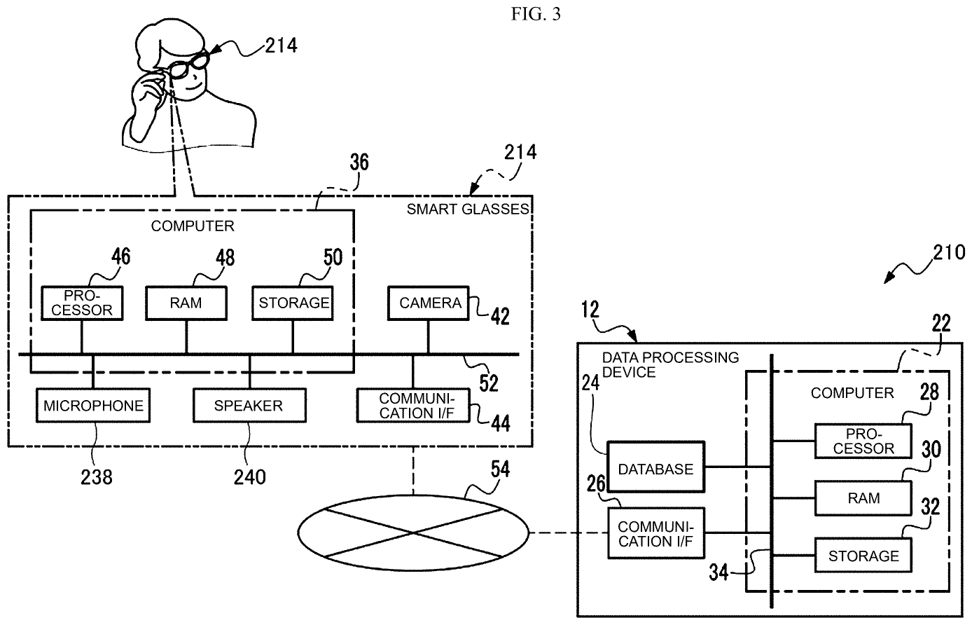

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

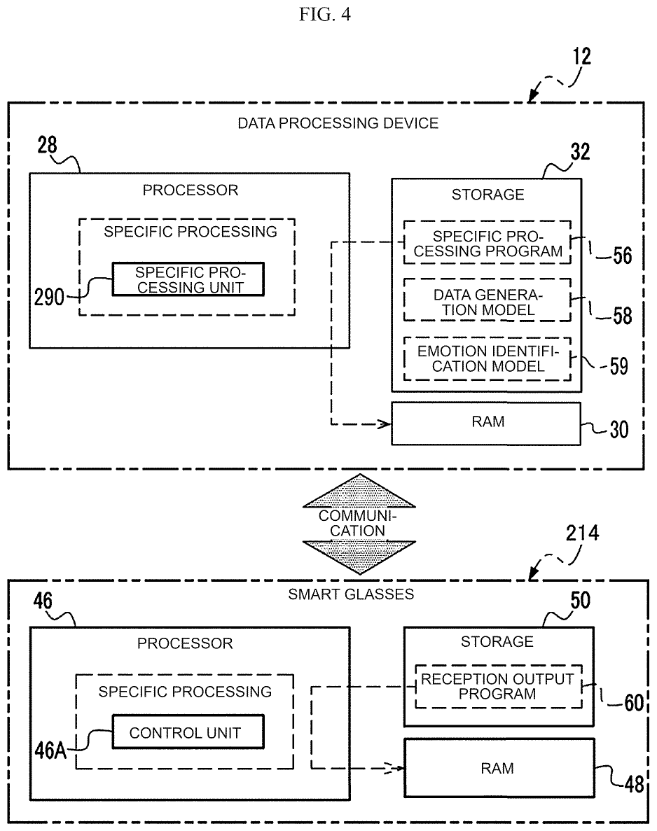

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

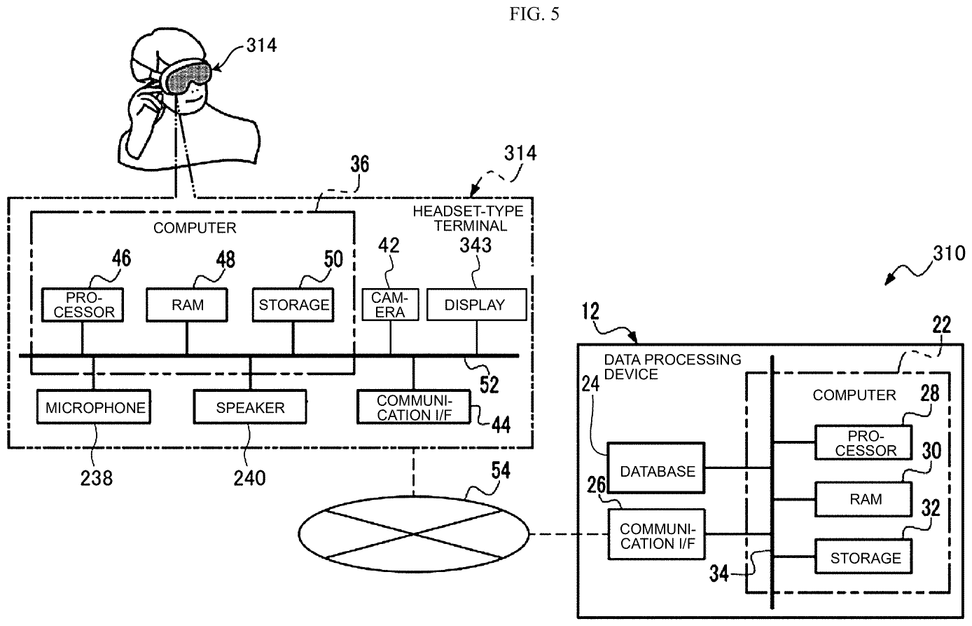

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

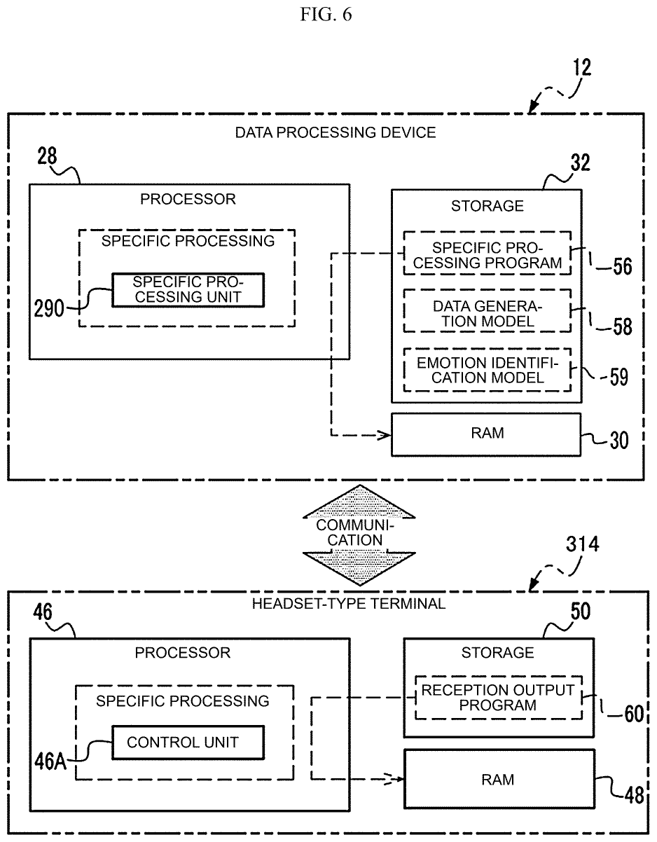

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

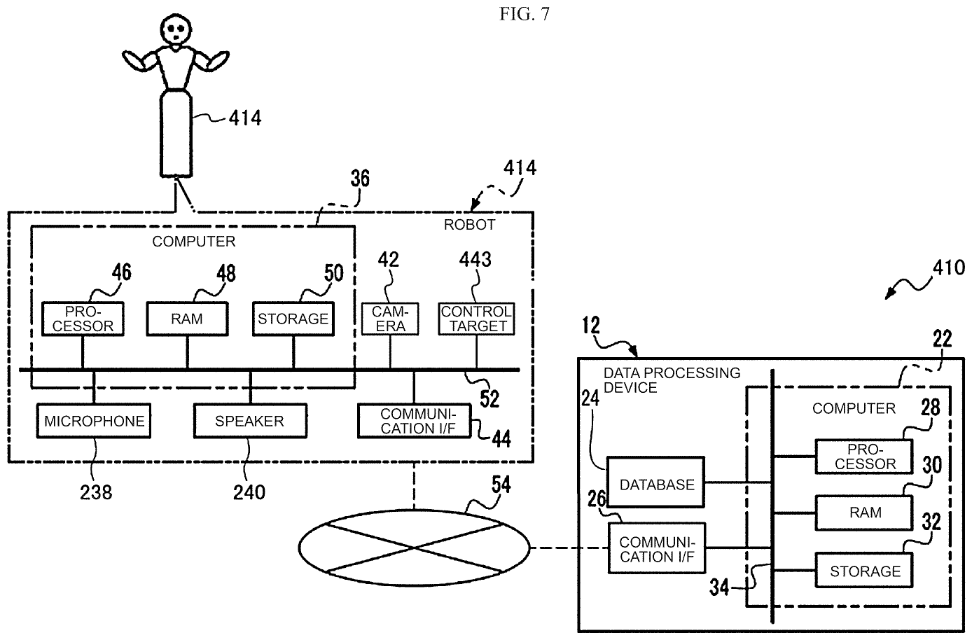

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

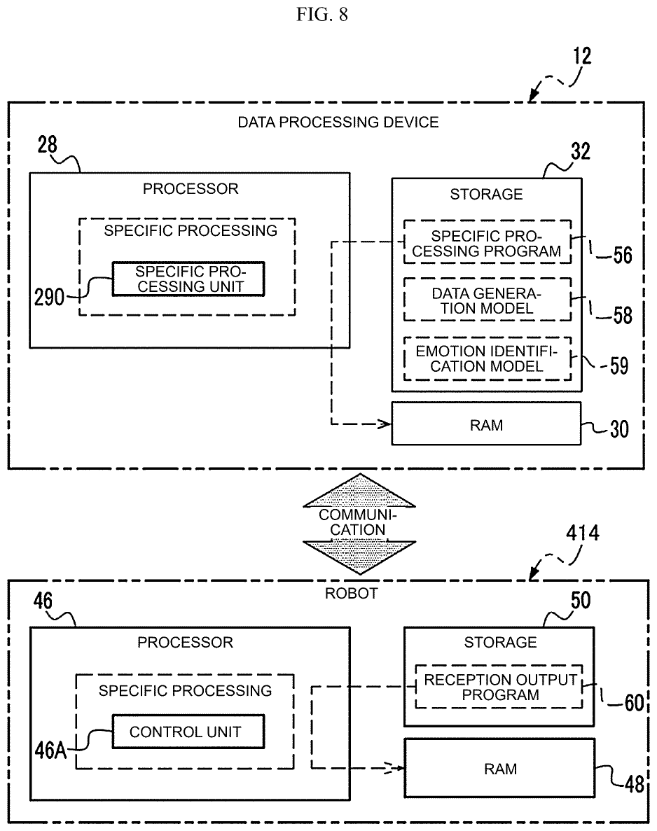

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.” (Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

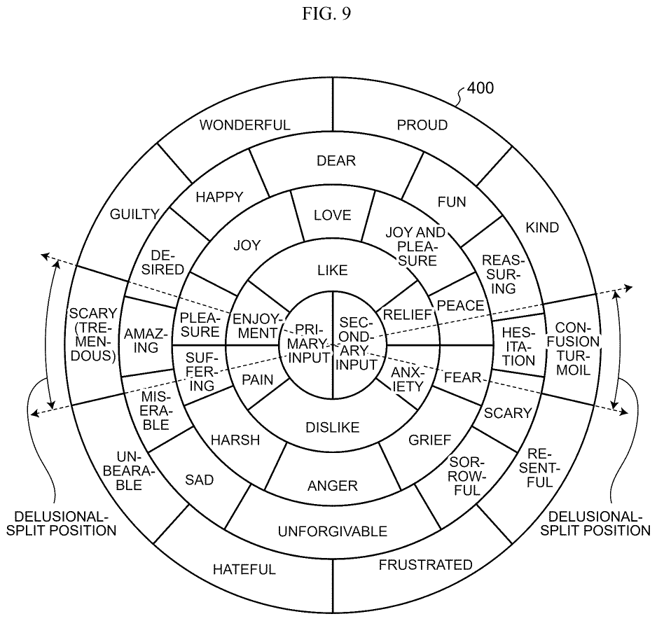

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

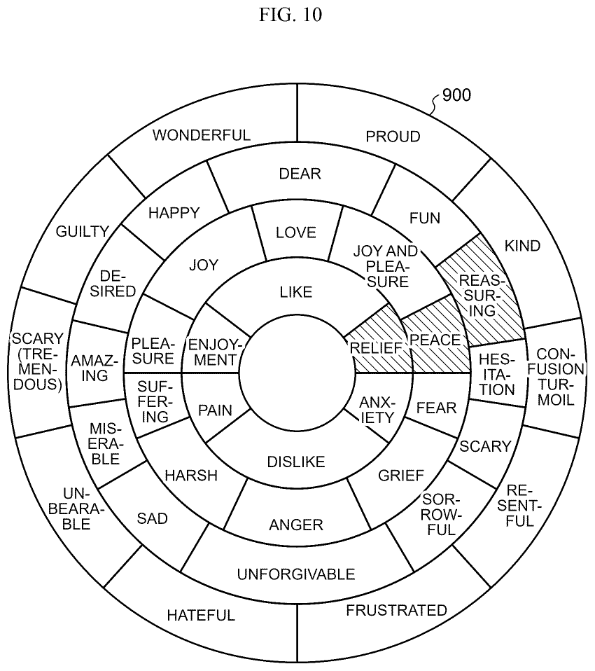

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A nursing care site support system comprising: a consultation receiving unit; an analysis unit; and a support guidance unit, wherein the consultation receiving unit is configured to receive consultation content regarding work-related worries and stress, trouble with users and colleagues, harassment, overwork, a sense of isolation, burnout, and the like from a nursing care staff member by text or voice input, and record the consultation content as a session log together with accompanying information such as time information, a staff ID or an anonymous token, a terminal type, and a consultation category; the analysis unit is configured to perform keyword extraction and summary generation by a natural language processing model on the received consultation content using generative AI, calculate a negative emotion score and a stress index by an emotion analysis model, further search for a case having a keyword matching or similar to the consultation content by referring to an in-house past nursing care case database, and extract a countermeasure and an effect of the past case; the support guidance unit is configured to automatically generate optimal feedback and advice for the nursing care staff member by the generative AI based on a determination result by the analysis unit and the countermeasure of the past case, specify a support destination such as a psychologist, a care manager, or a consultation desk as necessary to automatically set an appointment with the support destination, and further automatically generate a report including a summary of the consultation content, an analysis result, advice, appointment information, and the like to provide the report to the support destination in advance; and the nursing care site support system has a function of anonymizing personal information for privacy protection of the staff member in all processes, and provides an environment in which the staff member at a nursing care site can consult with peace of mind.

### Supplementary Note 2

The nursing care site support system according to Supplementary Note 1, wherein the consultation receiving unit is configured to input the consultation content received from the nursing care staff member into the natural language processing model and the emotion analysis model by the generative AI, extract a keyword such as abusive language, ignoring, overwork, user trouble, isolation, exhaustion, mental burden, or burnout from the consultation content, and calculate the negative emotion score to be high when an expression such as painful, suffering, or exhaustion is included; the analysis unit is configured to automatically determine presence or absence of harassment or a mental burden using such information; and the support guidance unit is configured to provide specific advice and a proposal of an appropriate support destination to the nursing care staff member based on the determination result, and execute the automatic setting of the appointment and the automatic generation of the report as necessary.

### Supplementary Note 3

The nursing care site support system according to Supplementary Note 1, wherein the analysis unit is configured to refer to the in-house past nursing care case database, search for a plurality of past cases having a keyword matching or similar to the consultation content, extract a countermeasure and an effect in the past cases, and provide the countermeasure and the effect to the support guidance unit; and the support guidance unit is configured to automatically generate optimal feedback and advice for the nursing care staff member using the generative AI based on such information, and further automatically describe a main point of the past cases in the report to the support destination.

What is claimed is:

1. A system comprising:
circuitry configured to:
receive, via a communication interface coupled to a packet-switched network, session text data from a terminal device, and store the session text data as a session log record with a timestamp in a storage device;
apply a natural language processing model to the session text data to generate a keyword feature vector and a session summary text, apply an emotion analysis model to generate an emotion score indicating an intensity of negative emotional content in the session text data, and apply a pattern classification model to the keyword feature vector and the emotion score to generate an issue classification label;
retrieve past case records from a case database by computing cosine similarity scores between a query embedding vector derived from the keyword feature vector and stored case record embedding vectors, and rank retrieved past case records by relevance score;
apply a generative neural network model to the issue classification label, the session summary text, and the ranked past case records to generate a response guidance data record comprising a recommended action sequence and a referral routing data record; and
transmit the response guidance data record to the terminal device via the communication interface.

2. The system according to claim 1, wherein the circuitry is configured to receive audio waveform data from the terminal device via the communication interface, apply a speech recognition model to convert the audio waveform data into session text, apply the emotion analysis model to acoustic features extracted from the audio waveform data to compute an acoustic emotion score, and fuse the acoustic emotion score with the text-derived emotion score to generate a combined emotion indicator.

3. The system according to claim 2, wherein the circuitry is configured to apply an analog-to-digital converter to the audio waveform data at the terminal device to generate digital audio data, packetize the digital audio data, and transmit the packetized audio data to the system via the communication interface, the system applying the speech recognition model to the packetized audio data on a dedicated hardware accelerator node.

4. The system according to claim 1, wherein the circuitry is configured to apply the emotion analysis model to the session text data by tokenizing the session text and computing an attention-weighted representation of emotionally salient token sequences, and output the emotion score as a continuous numerical value on a standardized scale.

5. The system according to claim 4, wherein the circuitry is configured to apply the pattern classification model to a concatenated feature vector comprising the keyword feature vector and the emotion score to generate the issue classification label from a plurality of classification categories, and compute a classification confidence score for the generated issue classification label.

6. The system according to claim 1, wherein the circuitry is configured to apply an anonymization transformation to the session text data prior to natural language processing by replacing personally identifiable identifiers with anonymized tokens while preserving semantic content, and store anonymized session log records separately from identified user records in the storage device.

7. The system according to claim 6, wherein the circuitry is configured to apply a privacy protection policy by processing anonymized session text data only within a designated secure processing environment, applying encryption to all session log records at rest, and enforcing a data retention policy that deletes session log records after a configurable retention period.

8. The system according to claim 1, wherein the circuitry is configured to generate the referral routing data record by applying the generative neural network model to the issue classification label and an organizational resource registry to identify an optimal support resource identifier and a contact scheduling parameter, and transmit the referral routing data record to the identified support resource endpoint via the communication interface.

9. The system according to claim 8, wherein the circuitry is configured to transmit an automated appointment request to a scheduling service endpoint via the communication interface based on the referral routing data record and the contact scheduling parameter, receive a confirmation record from the scheduling service endpoint, and transmit the confirmation record to the terminal device.

10. The system according to claim 1, wherein the circuitry is configured to store the session log record, keyword feature vector, emotion score, issue classification label, and response guidance data record in the storage device as a consultation record associated with a user identifier, and update a longitudinal consultation history record for the user identifier by appending the new consultation record.

11. The system according to claim 10, wherein the circuitry is configured to apply the natural language processing model to the longitudinal consultation history record to detect trend patterns in emotion scores and issue classification labels over time, generate a trend indicator data record when a sustained negative trend is detected, and transmit the trend indicator data record to a designated support resource terminal device.

12. The system according to claim 1, wherein the circuitry is configured to aggregate issue classification labels and emotion scores across all user identifiers over a configurable time window, apply a statistical analysis model to identify category-level trends and organizational pattern indicators, generate a portfolio trend report, and transmit the portfolio trend report to terminal devices associated with administrative user identifiers.

13. The system according to claim 1, wherein the circuitry is configured to receive feedback data from the terminal device or the referral routing destination following completion of a consultation session, store the feedback data as a new case record in the case database, and update the case record embedding vector index in the vector database with the new case record embedding vector.

14. The system according to claim 1, wherein the circuitry is configured to apply a multilingual translation model to session text data received in languages other than the system processing language, generate translated session text data, and apply the natural language processing model to the translated session text data.

15. The system according to claim 1, wherein the circuitry is configured to apply a load balancer to distribute incoming session text processing requests across a plurality of natural language processing model inference nodes, and route requests requiring specialized analysis to dedicated classifier nodes based on a preliminary issue category estimate.

16. The system according to claim 1, wherein the circuitry is configured to update the generative neural network model by generating training pairs from historical consultation records and corresponding validated response outcome records, and fine-tune the model to improve response guidance relevance for specific issue classification patterns.

17. The system according to claim 1, wherein the session text data comprises consultation content submitted by a user describing a workplace concern, the issue classification label corresponds to a consultation issue category identifier, and the response guidance data record provides recommended action sequences and organizational referral routing specific to the classified issue type.

18. A system comprising:
circuitry configured to:
receive, via a communication interface coupled to a packet-switched network, session text data from a terminal device and store it as a session log record;
apply a natural language processing model to generate a keyword feature vector, apply an emotion analysis model to generate an emotion score, and apply a pattern classification model to generate an issue classification label;
retrieve past case records by cosine similarity search, and apply a generative neural network model to generate response guidance data comprising a recommended action sequence and a referral routing data record;
apply an anonymization transformation and privacy protection policy to session data, and aggregate issue classification trends for portfolio reporting; and
transmit response guidance data records to terminal devices and referral routing data to support resource endpoints.

19. The system according to claim 18, wherein the circuitry is configured to apply the natural language processing model to a longitudinal consultation history record to detect sustained negative trend patterns in emotion scores and issue classification labels, generate trend indicator data records, and receive feedback data from consultation outcomes to update the case database and vector database.

20. A method comprising:
receiving, via a communication interface coupled to a packet-switched network, session text data from a terminal device, and storing the session text data as a session log record in a storage device;
applying a natural language processing model to generate a keyword feature vector and a session summary, applying an emotion analysis model to generate an emotion score, and applying a pattern classification model to generate an issue classification label;
retrieving past case records by cosine similarity scoring and applying a generative neural network model to generate a response guidance data record comprising a recommended action sequence and a referral routing data record; and
transmitting the response guidance data record to the terminal device via the communication interface.
